(19) United States
(12) Patent Application Publication
(10) Pub. No.: US 2026/0303311 A1
(43) Pub. Date: Oct. 1, 2026

(54) INFORMATION PROCESSING METHOD AND APPARATUS, AND COMMUNICATION DEVICE AND STORAGE MEDIUM

(71) Applicant: BEIJING XIAOMI MOBILE SOFTWARE CO., LTD., Beijing (CN)

(72) Inventor: Lei WANG, Beijing (CN)

(73) Assignee: Beijing Xiaomi Mobile Software Co., Ltd., Beijing (CN)

(21) Appl. No.: 19/478,333

(22) PCT Filed: Apr. 25, 2023
(86) PCT No.: PCT/CN2023/090652

§ 371 Date: Oct. 24, 2025

(51) Int. Cl. H04L 5/14; H04B 7/06; H04L 5/00; H04W 72/231

(52) U.S. Cl. CPC H04L 5/14; H04L 5/0094; H04W 72/231; H04B 7/06952

(57) ABSTRACT

The present disclosure provides an information processing method, a communication device, and a storage medium. The information processing method is executed by a UE, includes: receiving beam indication information sent by a network device, wherein the beam indication information is configured for indicating a beam for transmission in an SBFD time unit.

### CROSS REFERENCE TO RELATED APPLICATIONS

The present disclosure is the U.S. national phase application of International Application No. PCT/CN2023/090652 filed on Apr. 25, 2023, the content of which is incorporated herein by reference in its entirety for all purposes.

### TECHNICAL FIELD

The present disclosure relates, but is not limited, to the field of wireless communication technology, in particular, to an information processing method, an information processing apparatus, a communication device, and a storage medium.

### BACKGROUND

The communication between the user equipment (UE) and the access network device is based on a carrier component (CC). In order to improve the uplink (UL) coverage and/or communication system throughput, a Sub Band Full Duplex (SBFD) time unit is proposed.

The CC is divided into multiple sub bands (SBs). The SBs can be divided into UL sub bands, downlink (DL) sub bands, etc. Under normal circumstances, UL transmission is carried out in the UL sub bands and DL transmission is carried out in the DL sub bands.

In the time domain, the SBFD time unit can be configured on a DL time unit, a UL time unit, or a flexible (F) time unit. If the frequency domain resources corresponding to a time unit involve both UL and DL sub bands, such a time unit is the above SBFD time unit.

The horizontal axis in FIG. 1 is a time axis (also known as a time domain axis), and the vertical axis is a frequency axis (also known as a frequency domain axis). The 2^{nd} to 4^{th} time units are the SBFD time units, which support bidirectional UL and DL transmissions due to the simultaneous use of DL and UL sub bands.

### SUMMARY

According to a first aspect of the present disclosure, an information processing method is provided, wherein the method is performed by a user equipment (UE), and the method includes:

receiving beam indication information sent by a network device, wherein the beam indication information is configured to indicate a beam for transmission in a Sub Band Full Duplex (SBFD) time unit.

According to a second aspect of the present disclosure, an information processing method is provided, wherein the method is performed by a network device, and the method includes:
sending beam indication information to a user equipment (UE), wherein the beam indication information is configured to indicate a beam for transmission in a Sub Band Full Duplex (SBFD) time unit.

According to a third aspect of the present disclosure, an information processing apparatus is provided, and the apparatus includes:
receiving module configured to receive beam indication information sent by a network device, wherein the beam indication information is configured to indicate a beam for transmission in a Sub Band Full Duplex (SBFD) time unit.

According to a fourth aspect of the present disclosure, an information processing apparatus is provided, and the apparatus includes:
a sending module configured to send beam indication information to a user equipment (UE), wherein the beam indication information is configured to indicate a beam for transmission in a Sub Band Full Duplex (SBFD) time unit.

According to a fifth aspect of the present disclosure, an information processing method is provided, and the method includes:
the network device sends beam indication information to the UE, wherein the beam indication information is configured to indicate a beam for transmission in a Sub Band Full Duplex (SBFD) time unit; and the UE receives the beam indication information sent by the network device.

According to a sixth aspect of the present disclosure, a communication system is provided, and the system includes:
a user equipment (UE), configured to perform the method described in any of the first aspect of the present disclosure mentioned above; and a network device, configured to perform the method described in any of the second aspect of the present disclosure mentioned above.

According to a seventh aspect of the present disclosure, a communication device is provided. The communication device includes a processor, a transceiver, a memory, and an executable program stored in the memory and executable by the processor, wherein the processor is configured to execute the executable program to perform the information processing method described in any of the first aspect, the second aspect, or the fifth aspect of the present disclosure.

According to an eighth aspect of the present disclosure, a computer storage medium is provided, which stores an executable program. When the executable program is executed by a processor, the information processing method described in any of the first aspect, the second aspect, or the fifth aspect of the present disclosure is implemented.

It should be understood that the general description above and the detailed description in the following are only illustrative and explanatory, and do not limit the present disclosure.

### BRIEF DESCRIPTION OF THE DRAWINGS

The drawings here are incorporated into the specification and form a part of the specification, illustrating embodiments in accordance with the present disclosure and serving together with the specification to explain the principles of the embodiments of the present disclosure.

FIG. 1 is a schematic diagram of communication resources according to one or more embodiments;

FIG. 2 is a schematic diagram of a structure of a wireless communication system according to one or more embodiments;

FIG. 3A is a schematic diagram illustrating relationships between radio frequency chains and different types of time units according to one or more embodiments;

FIG. 3B is a schematic diagram illustrating interference according to one or more embodiments;

FIG. 4A is a flowchart of an information processing method according to one or more embodiments;

FIG. 4B is a flowchart of an information processing method according to one or more embodiments;

FIG. 5A is a flowchart of an information processing method according to one or more embodiments;

FIG. 5B is a flowchart of an information processing method according to one or more embodiments;

FIG. 6A is a schematic diagram of beam activation or deactivation based on an MAC CE in a time-domain according to one or more embodiments;

FIG. 6B is a schematic diagram of an MAC CE according to one or more embodiments;

FIG. 7 is a flowchart of an information processing method according to one or more embodiments;

FIG. 8 is a flowchart of an information processing method according to one or more embodiments;

FIG. 9 is a schematic diagram of a structure of an information processing apparatus according to one or more embodiments;

FIG. 10 is a schematic diagram of a structure of an information processing apparatus according to one or more embodiments;

FIG. 11 is a schematic diagram of a structure of a UE according to one or more embodiments; and

FIG. 12 is a schematic diagram of a structure of a network device according to one or more embodiments.

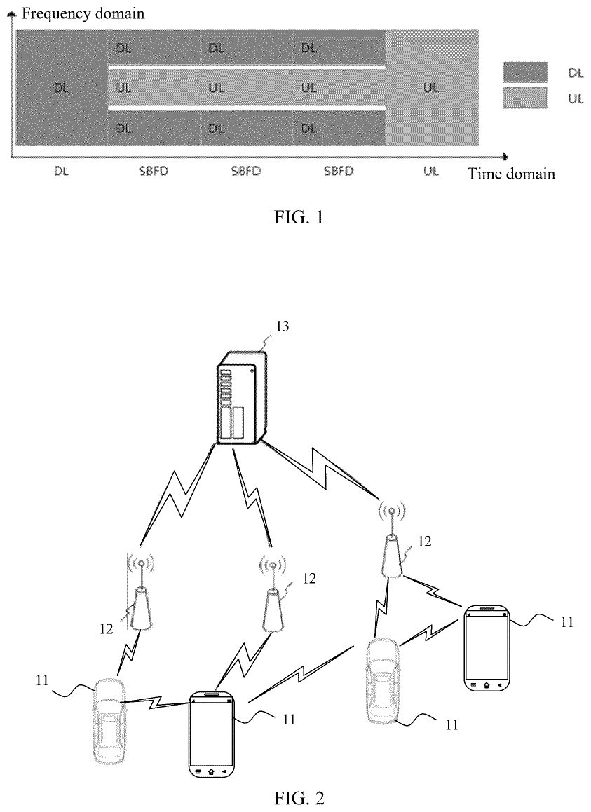

### DETAILED DESCRIPTION

Exemplary embodiments will be described in detail here, with examples shown in the drawings. When the following description refers to the drawings, unless otherwise indicated, the same reference numerals in different drawings represent the same or similar elements. The embodiments described in the following exemplary embodiments do not represent all embodiments consistent with the present disclosure. On the contrary, they are only examples of devices and methods consistent with some aspects of the present disclosure as described in the appended claims.

The terms used in embodiments of the present disclosure are for the purpose of description of specific embodiments only, and are not intended to limit the embodiments of the present disclosure. Singular forms such as “a” and “the” used in the present disclosure are also intended to include plural forms, unless other meanings are clearly indicated in the context. It should also be understood that the term “and/or” used in the present disclosure refers to and includes any or all possible combinations of one or more listed items related.

It should be understood that although terms such as first, second, and third may be used to describe various information in embodiments of the present disclosure, such information should not be limited to these terms, which are only used to distinguish information of the same type from each other. For example, without departing from the scope of the present disclosure, the first information can also be referred to as the second information, and similarly, the second information can also be referred to as the first information. The word “if” used herein can be interpreted as “when” or “while” or “in response to determination that”, depending on the context.

As shown in FIG. 2, a schematic diagram of a structure of a wireless communication system according to one or more embodiments is provided. As shown in FIG. 2, the wireless communication system is a communication system based on Cellular Mobile Communication technology and can include several UEs 11, several access network devices 12, and/or at least one core network device 13.

The UE 11 can be equipment that provides voice and/or data connectivity to a user. The UE 11 can communicate with one or more core networks via a Radio Access Network (RAN). The UE 11 can be Internet of Things (IoT) UE, for example, a sensor device, a mobile phone (or referred to as a cellular phone), and a computer with IoT user equipment, such as fixed, portable, pocket, handheld, computer built-in, or vehicle mounted devices. For example, stations (STA), subscriber units, subscriber stations, mobile stations, mobiles, remote stations, access points, remote terminals, access terminals, user terminals, user agents, user devices or UEs. Alternatively, the UE 11 can also be a device for unmanned aerial vehicles. Alternatively, the UE 11 can also be an onboard device, such as a trip computer with wireless communication capability or wireless user equipment connected to an external trip computer. Alternatively, the UE 11 can also be a roadside device, such as a street light, a signal light, or other roadside devices with the wireless communication function, etc.

The access network device 12 can be a network side device in the wireless communication system. The wireless communication system can be the 4th generation (4G) mobile communication system, also known as the Long Term Evolution (LTE) system. Alternatively, the wireless communication system can also be the 5th generation (5G) system, also known as the New Radio system or the 5G NR system. Alternatively, the wireless communication system can also be the next generation system following 5G system. The access network in 5G system can be referred to as the New Generation-Radio Access Network (NG-RAN), or the MTC system.

The access network device 12 can be the Evolved Node B (eNB) employed in the 4G system. Alternatively, the access network device 12 can also be the next Generation Node B (gNB) constructed in a centralized and distributed architecture in the 5G system. When constructed in the centralized and distributed architecture, the access network device 12 usually includes a central unit (CU) and at least two distributed units (DUs). The central unit is provided with protocol stacks for the Packet Data Convergence Protocol (PDCP) layer, the Radio Link Control (RLC) layer, and the Medium Access Control (MAC) layer. The distributed unit is provided with a protocol stack for the Physical (PHY) layer. Specific implementations of the access network device 12 are not limited in embodiments of the present disclosure.

A wireless connection can be established between the access network device 12 and the UE 11 via a wireless air interface. In different implementations, the wireless air interface is based on the 4th generation (4G) mobile communication network technology standard. Alternatively, the wireless air interface is based on the 5th generation (5G) mobile communication network technology standard, for example, the wireless air interface is the New Radio. Alternatively, the wireless air interface can also be a wireless air interface based on the next generation mobile communication network technology standard following 5G

The core network device can include, but is not limited to, at least one of the following: an Access Management Function (AMF), a Session Management Function (SMF), and/or a User Plane Function (UPF).

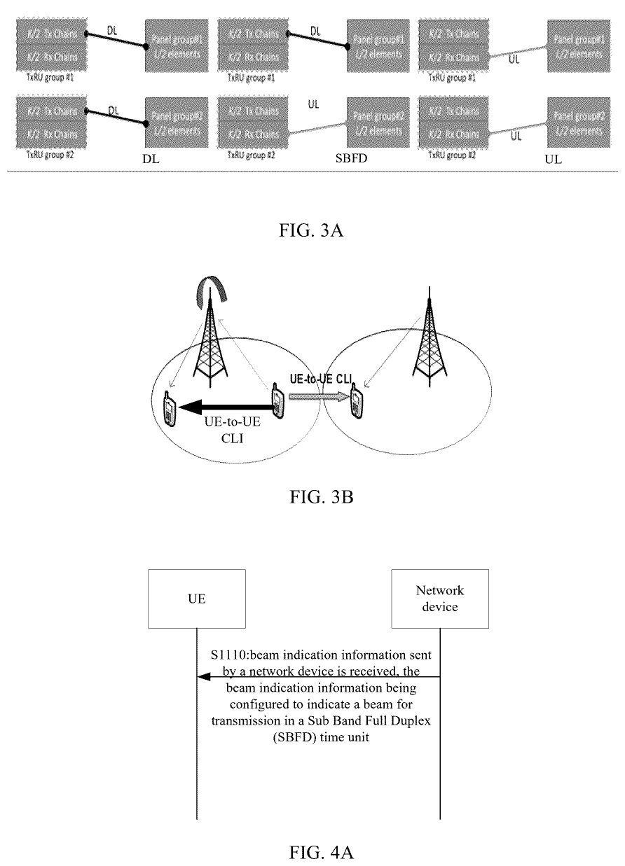

As shown in FIG. 3A, the following optional ways are available for the antenna configuration for the SBFD network device.

For each DL time unit, K transmit RF chains (Tx Chains) are configured for DL transmission. For example, two K/2 transmit RF chains are configured in Transceiver Unit (TxRU) Group #1 and Group #2 for DL transmission. An antenna radio frequency (RF) chain can correspond to one or more antenna elements within an antenna panel group.

For each SBFD time unit, K/2 transmit RF chains (Tx Chains) are configured for DL transmission, and K/2 receive RF chains (Rx Chains) are configured for UL reception.

For each UL time unit, K receive RF chains (Rx Chains) are configured for UL reception.

In the wireless communication system, the network device indicates the beam that the network device uses. The UE determines the corresponding receive beam for downlink reception based on the network device's transmit beam, and/or the UE determines the UE's own transmit beam for uplink transmission based on the network device's receive beam.

The network device uses different numbers of transmit radio frequency chains for downlink transmission in DL and SBFD time units, resulting in the following differences in the UE's receive beams in DL and SBFD time units.

The network device uses different numbers of beams in DL and SBFD time units, and thus resulting in different optimal beams using by the same UE for downlink reception in DL and SBFD time units.

The network device uses the same number of beams in DL and SBFD slots, but for the same beam, the beam gains differ in DL and SBFD time units, which results in different optimal beams using by the same UE for downlink reception in DL and SBFD time units.

At the same time, the network device transmits and receives simultaneously in the SBFD time unit. When receiving DL signals, the UE may experience interference from UL signals transmitted by other UEs corresponding to the same network device or from UEs corresponding to other network devices.

As shown in FIG. 3B, the interference from the UL signals on DL signals can be referred to as UE-UE Cross Link Interference (UE-to-UE CLI). In order to avoid strong UE-to-UE CLI, the network device can select a different beam for DL transmission in an SBFD time unit than in a DL time unit. This approach is equivalent to suppressing the UE-to-UE CLI through spatial isolation and is referred to as spatial UE-to-UE CLI suppression.

Therefore, in some cases, the beams used for transmission in an SBFD time unit is required for an additional configuration to ensure the communication quality.

It should be noted that the time unit in the present disclosure can include a frame, a sub-frame, a slot, a mini-slot, a sub-slot, a transmission time interval (TTI), etc. The present disclosure is not limited to this.

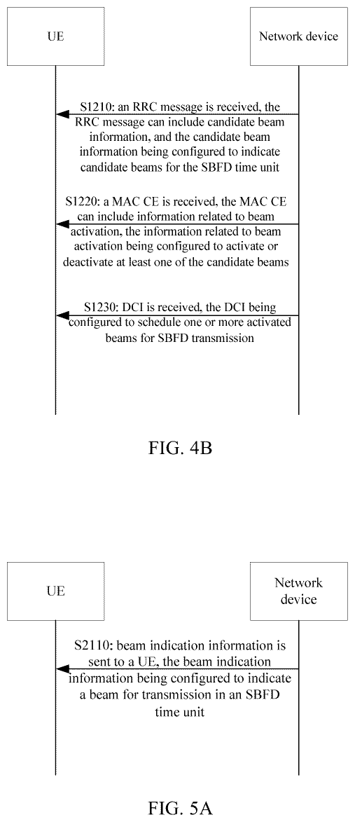

As shown in FIG. 4A, embodiments of the present disclosure provide an information processing method. The information processing method is performed by a user equipment (UE), and the method includes following steps.
S1110: beam indication information sent by a network device is received, the beam indication information being configured to indicate a beam for transmission in a Sub Band Full Duplex (SBFD) time unit.

The UE can be any communication device as shown in FIG. 2. The communication device can take the form of a mobile phone, a tablet computer, a wearable device, a vehicle mounted device, a smart office device, and/or a smart home device.

The network device can include, but is not limited to, the access network device as shown in FIG. 2. The access network device can be any access network device as described in FIG. 2.

In some embodiments, the SBFD time unit can include, but is not limited to, at least one of the following:
an SBFD slot;
an SBFD mini-slot;
an SBFD symbol;
an SBFD sub-frame;
an SBFD frame, etc.

The SBFD time unit supports both uplink and downlink transmissions of the UE. The SBFD time unit can be flexibly used based on transmission needs.

The beam indication information can be used for the UE to determine candidate beams for the uplink transmission and/or downlink transmission in the SBFD time unit, or to determine a target beam from the candidate beams. The candidate beams can be used as alternative beams for transmission in the SBFD time unit. The target beam is the beam ultimately used for transmission in the SBFD time unit. The target beam can be one or more of the candidate beams.

In some embodiments, the beam indication information includes at least one of the following:
Transmission Configuration Indicator State (TCI-State) set information, the TCI-State set information being configured to indicate a beam set, and the beam set including one or more beams;
a TCI-State identifier (ID), which indicates a beam.

In some embodiments, the TCI-State set information can include at least a TCI-State set identifier. Therefore, the beam indication information can indicate, in the form of a TCI-State set, candidate beams and/or target beams for transmission in an SBFD time unit.

The TCI-State set can include one or more TCI-States, with each TCI-State corresponding to one beam. A TCI-State identifier can indicate one beam.

In embodiments of the present disclosure, the beam indication information sent by the network device is received, and a beam specifically used for the transmission in an SBFD time unit is determined based on the beam indication information, so as to enable the beam used for the transmission in the SBFD time unit to be different from the beam used for the transmission in the DL or UL time unit, thereby achieving the UE-to-UE CLI suppression and improving the communication quality of the SBFD time unit.

In some embodiments, the beam indication information includes at least one of the following:
candidate beam information included in a Radio Resource Control (RRC) message, the candidate beam information being configured to indicate the candidate beam for the SBFD time unit;
information related to beam activation included in a Media Access Control (MAC) Control Element (CE), the information related to beam activation being configured to activate or deactivate at least one candidate beam;
scheduling information included in Downlink Control Information (DCI), the scheduling information being configured to schedule one or more activated beams for SBFD transmission.

In some embodiments, the activated candidate beams are candidate beams for an SBFD time unit or candidate beams for a DL time unit.

In some embodiments, as shown in FIG. 4B, embodiments of the present disclosure provide an information processing method, performed by a UE, and the method includes following steps.
S1210: an RRC message is received, the RRC message can include candidate beam information, and the candidate beam information being configured to indicate candidate beams for the SBFD time unit.
S1220: an MAC CE is received, the MAC CE can include information related to beam activation, and the information related to beam activation being configured to activate or deactivate at least one of the candidate beams.
S1230: DCI is received, the DCI being configured to schedule one or more activated beams for SBFD transmission.

In some embodiments, the RRC message is a configuration message for candidate beams for transmission in the SBFD time unit.

The MAC CE includes information related to beam activation, which can include activation information and/or deactivation information. The activation information is configured to activate one or more candidate beams configured through the RRC message. The deactivation information can be configured to deactivate one or more activated candidate beams. It should be understood that a period after the UE receives a first MAC CE, the UE receives a second MAC CE. The information related to beam activation in the second MAC CE is different from that in the first MAC CE. It should be understood that the UE determines the activated candidate beams based on the first MAC CE. After receiving the second MAC CE, the UE will re-determine the information about activated beams based on the second MAC CE. The first MAC CE and the second MAC CE can be used to activate some or all candidate beams.

If a candidate beam is ready for use after being activated, it can be selected as the target beam for the transmission in the SBFD time unit.

Both the RRC message and the MAC CE are high-layer signaling, while the DCI is physical layer signaling, which has the characteristics of low latency. The DCI can be used to select the target beam for the transmission in the SBFD time unit from one or more candidate beams activated by the MAC CE.

In some embodiments, the number of candidate beams activated or deactivated by the MAC CE is less than or equal to the number of candidate beams configured in the RRC message. In other embodiments, the number of target beams scheduled by the DCI is less than or equal to the number of candidate beams activated by the MAC CE.

In some embodiments, the beam indication information included in the RRC message, the MAC CE, and the DCI can be all bitmaps. Each bit in the bitmap indicates one TCI-State, and each TCI-State corresponds to one beam.

In this case, the number of candidate beams configured by the RRC message can be determined based on the number of bits of an Information Element (IE) included in the RRC message. The number of candidate beams that can be activated or deactivated by the MAC CE can depend on the length of the MAC CE. The target beam(s) that is/are scheduled by the DCI can depend on the length of the DCI. The length of the DCI can be the number of bits contained by the DCI.

In some embodiments, the beam indication information included in the RRC message can indicate a TCI-State set, and any TCI-State in the TCI-State set corresponds to a candidate beam. By configuring candidate beams in the RRC message using a TCI-State set, the signaling overhead of the RRC message can be reduced.

The information related to candidate beam activation included in the MAC CE can be a bitmap indicating the candidate beams in the TCI-State set. The length of the information related to candidate beam activation included in the MAC CE is equal to the number of TCI-States in the TCI-State set. The m^{th} bit is used to indicate whether the TCI-State with a TCI-State identifier ‘m’ in the TCI-State set is a candidate beam.

The DCI can include a field indicating the use of the m^{th} candidate beam. The target beam is determined based on the TCI-State identifier of the m^{th} candidate beam in the MAC CE and the TCI-State set configured in the RRC message. In this case, the value of the field included in the DCI is m.

In some embodiments, the beam indication information included in the RRC message can indicate a TCI-State set, and any TCI-State in the TCI-State set corresponds to a candidate beam. By configuring candidate beams in the RRC message using a TCI-State set, the signaling overhead of the RRC message can be reduced.

The information related to candidate beam activation included in the MAC CE can also indicate a TCI-State set, a TCI-State subset, and/or a TCI-State identifier, etc. For example, if the RRC message configures multiple TCI-State sets, the MAC CE can activate or deactivate some of the TCI-State sets using the information related to candidate beam activation. For another example, if the RRC message configures a single TCI-State set, the MAC CE can activate or deactivate a TCI-State subset using the information related to candidate beam activation. A TCI-State subset can include one or more TCI-States in the TCI-State set. If the MAC CE activates or deactivates candidate beams by including TCI-State set information or TCI-State subset information (e.g., an identifier indicating a TCI-State subset), the signaling overhead of the MAC CE can be reduced.

The DCI can include a TCI-State identifier or a beam identifier to directly indicate the target beam selected from the activated candidate beams.

The DCI can include a field indicating the use of the m^{th} candidate beam. The target beam is determined based on the TCI-State identifier of the m^{th} candidate beam in the MAC CE and the TCI-State set configured in the RRC message. In this case, the value of the field included in the DCI is m.

In this way, by using the configuration through the RRC message, the activation or deactivation through the MAC CE, and scheduling through the DCI, the selection, according to needs, of appropriate transmit and/or receive beams for the communication in corresponding SBFD time units at different communication times can be achieved.

In some embodiments, both the RRC message and the MAC CE can include a single TCI-State identifier and/or a single beam identifier to implement beam configuration, activation or deactivation, scheduling, and other beam indications for the SBFD time unit.

In some embodiments, the RRC message includes at least one of the following:
the RRC message includes first candidate beam information and second candidate beam information, the first candidate beam information being configured to indicate a candidate beam for a downlink (DL) time unit, and the second candidate beam information being configured to indicate a candidate beam for an SBFD time unit; or the RRC message includes third candidate beam information, the third candidate beam information being configured for transmission in both the DL time unit and the SBFD time unit.

In embodiments of the present disclosure, a single RRC message includes both the first candidate beam information and the second candidate beam information. The first candidate beam information indicates the candidate beam for the DL time unit, and the second candidate beam information indicates the candidate beam for the SBFD time unit. In some embodiments, a single RRC message can include two IEs, one for including the first candidate beam information and the other for including the second candidate beam information. In other embodiments, a single RRC message can include one IE including the beam indication information, with different fields of the IE being used to include the first candidate beam information and the second candidate beam information, respectively.

In some embodiments, the TCI-State identifier included in the first candidate beam information and the TCI-State identifier included in the second candidate beam information can be the same.

In some embodiments, the TCI-State identifier included in the first candidate beam information and the TCI-State identifier included in the second candidate beam information can be different.

In some embodiments, the candidate beams configured in the RRC message can be shared candidate beams used for both the DL time unit and the SBFD time unit. In this case, the RRC message can include a single IE, and all beams indicated by the IE are candidate beams for both the DL time unit and the SBFD time unit.

In some embodiments, the TCI-State identifiers included in the third candidate beam information can be different from each other.

In some embodiments, the IE can include, but is not limited to, a Physical Downlink Shared Channel Configuration (PDSCH-Config) IE.

The above are merely examples of the RRC message including the beam indication information, and the specific implementations are not limited to this.

In some embodiments, the number of candidate beams that can be configured by the third candidate beam information is greater than the number of candidate beams that can be configured by the first candidate beam information; and/or the number of candidate beams that can be configured by the third candidate beam information is greater than the number of candidate beams that can be configured by the second candidate beam information.

Since the DL time unit and the SBFD time unit share the same candidate beams, in order to distinguish between the DL time unit and the SBFD time unit for scheduling, the number of beams that can be configured by the third candidate beam information can be greater than the number of candidate beams that can be configured by the first candidate beam information, and/or the number of beams that can be configured by the third candidate beam information can be greater than the number of candidate beams that can be configured by the second candidate beam information.

For example, if the first candidate beam information and the second candidate beam information can configure 128 candidate beams, then the third candidate beam information can configure a number greater than 128 candidate beams. For example, the third candidate beam information can configure 256 candidate beams.

In some embodiments, during actual configuration, the number of candidate beams that can be configured using the third candidate beam information is greater than the number of candidate beams that can be configured using the first candidate beam information; and/or, the number of candidate beams that can be configured using the third candidate beam information is greater than the number of candidate beams that can be configured using the second candidate beam information.

That is, in the present disclosure, candidate beams can be configured for both the SBFD time unit and the DL time unit simultaneously using a single RRC message, resulting in a reduced number of RRC messages and signaling overhead.

It should be noted that in some embodiments, the candidate beams configured for the DL time unit can also be candidate beams for the F time unit, and/or candidate beams activated for the DL time unit can also be candidate beams for the F time unit, and/or beams scheduled for transmission in the DL time unit can also be used for transmission in the F time unit.

In some embodiments, the information related to beam activation includes:
first information related to the beam activation included in a first field of the MAC CE, the first information being configured to activate or deactivate at least one candidate beam for the DL time unit;
second information related to the beam activation included in a second field of the MAC CE, the second information being configured to activate or deactivate at least one candidate beam for the SBFD time unit.

In some embodiments, a single MAC CE can include activation or deactivation information for candidate beams for both SBFD and DL time units.

Specifically, in embodiments of the present disclosure, a single MAC CE can include two independent fields, one for including the first information and the other one for including the second information. The first information can be used to activate or deactivate the candidate beams for the DL time unit, and the second information can be used to activate or deactivate the candidate beams for the SBFD time unit. Both the first information and the second information can be represented through a bitmap, and two bit values of any bit in the bitmap can represent activation or deactivation, respectively.

In some other embodiments, the MAC CE used for activating or deactivating candidate beams for the transmission in the DL time unit is different from the MAC CE used for activating or deactivating candidate beams for the SBFD time unit.

The activation or deactivation of candidate beams for the SBFD time unit and the DL time unit are achieved using two MAC CEs, which allows for flexible activation or deactivation of candidate beams for SBFD and DL time units using different MAC CEs, depending on the transmission requirements of SBFD and DL time units, as well as channel conditions, etc.

If two MAC CEs are used to activate or deactivate candidate beams for the SBFD time unit and the DL time unit, respectively, the transmission resources for these two MAC CEs can be different. The transmission resources can be frequency domain resources and/or time domain resources.

In some embodiments, the MAC CE used for activating or deactivating candidate beams for the SBFD time unit is transmitted in the SBFD time unit, and/or the MAC CE used for activating or deactivating candidate beams for the DL time unit is transmitted in the DL time unit.

In this case, if the network device needs to send a MAC CE used for activating or deactivating candidate beams for the SBFD time unit, it can send the MAC CE in the SBFD time unit. If the network device needs to send a MAC CE used for activating or deactivating candidate beams for the DL time unit, it can send the MAC CE in the DL time unit. In this case, if a UE receives a MAC CE in an SBFD time unit, it can determine that the MAC CE is used to indicate the activation or deactivation of the candidate beams for the SBFD time unit. If a UE receives a MAC CE in a DL time unit, it can determine that the MAC CE is used to indicate the activation or deactivation of the candidate beams for the DL time unit.

In some embodiments, the bits of the MAC CE include first-category bits and second-category bits. The first-category bits are high-order bits relative to the second-category bits, or the second-category bits are high-order bits relative to the first-category bits.

The first-category bits include the first information, and/or the second-category bits include the second information.

In some embodiments of the present disclosure, a single MAC CE is used to include the information related to candidate beam activation for both the SBFD time unit and the DL time unit.

In some embodiments of the present disclosure, all bits of the MAC CE are divided into first-category bits and second-category bits. The first-category bits include the first information, and the second-category bits include the second information.

For example, an MAC CE can include 16 bytes, for a total of 128 bits. The first-category bits can be a continuously distributed portion of the 128 bits. Similarly, the second-category bits can also be a continuously distributed portion of the 128 bits. The number of the first-category bits and the number of the second-category bits can be the same or different.

Assuming that a MAC CE includes 128 bits, and the first-category bits and the second-category bits divide the 128 bits equally. The first-category bits and the second-category bits each occupy 64 bits. For example, if the first-category bits are high-order 64 bits of the 128 bits, then the second-category bits are low-order 64 bits of the 128 bits. In this case, the first-category bits are high-order bits relative to the second-category bits. For another example, if the first-category bits are low-order 64 bits of the 128 bits, then the second-category bits are high-order 64 bits of the 128 bits. In this case, the first-category bits are low-order bits relative to the second-category bits.

In some embodiments, the MAC CE further includes an indication bit, and the indication bit is configured to indicate whether the information related to beam activation contained in the MAC CE is for an SBFD time unit or a DL time unit.

The MAC CEs for the SBFD time unit and the DL time unit are different, and the MAC CEs can include an indication bit indicating whether the current MAC CE is for an SBFD time unit or for a DL time unit. The indication bit can include one or more bits.

In this case, the MAC CE for a DL time unit is not limited to being transmitted in the DL time unit, and similarly, the MAC CE for an SBFD time unit is not limited to being transmitted in the SBFD time unit.

Scheduling information for the SBFD time unit and the DL time unit can be included in the same DCI or in different DCI.

If the scheduling information for the SBFD time unit and the DL time unit is included in different DCI, the transmission resources for the two DCI can be different. The transmission resources can include, but are not limited to, time domain resources.

In some embodiments, if the downlink transmission scheduled by the DCI is in an SBFD time unit, the scheduling information is further configured to indicate that at least one activated candidate beam for the SBFD time unit is used for transmission in the SBFD time unit, and/or if the downlink transmission scheduled by the DCI is in a DL time unit, the scheduling information is further configured to indicate that at least one activated candidate beam for the DL time unit is used for transmission in the DL time unit.

In this way, if the DCI-scheduled downlink transmission received by the UE is located in the DL time unit, the activated beam indicated by the scheduling information included by the DCI can be the target beam for transmission in the DL time unit. If the DCI-scheduled downlink transmission received by the UE is located in the SBFD time unit, the activated beam indicated by the scheduling information included by the DCI can be the target beam for transmission in the SBFD time unit.

In some embodiments, the scheduling information includes a beam field.

The beam field is configured to indicate that at least one activated candidate beam is scheduled.

The activated candidate beam here is a candidate beam for the SBFD time unit or a candidate beam for the DL time unit.

The scheduling information can include a beam field, which can include an index of at least one activated candidate beam. For example, the activated candidate beam is a candidate beam for the SBFD time unit, and the value of the beam field is m, indicating the m^{th} candidate beam among the candidate beams activated for the SBFD time unit in the MAC CE. The target beam is determined based on the TCI-State identifier of the m^{th} candidate beam for the SBFD time unit in the MAC CE and the TCI-State for the SBFD time unit configured in the RRC message.

That is, the beam indicated by the beam field of the scheduling information is the target beam scheduled for transmission in the DL time unit or transmission in the SBFD time unit.

In some embodiments of the present disclosure, the downlink transmission includes but is not limited to PDSCH and/or PDCCH transmission.

In some embodiments, the scheduling information can also include a scheduling instruction, which indicates to perform the PDSCH transmission or the PDCCH transmission, or over which PDSCH and/or PDCCH to perform downlink transmission, etc.

In some embodiments, the beam field indicates at least one activated candidate beam.

The beam field can directly or indirectly indicate the at least one activated candidate beam.

For example, the beam field indicates an index of the activated candidate beam. The index can be used to determine the activated candidate beam. For example, the index corresponds to the TCI-State identifier, and each TCI-State identifier corresponds to a beam.

A beam corresponding to a first beam identifier is used for downlink transmission in a DL time unit, and/or a beam corresponding to a second beam identifier is used for downlink transmission in an SBFD time unit.

The second beam identifier is determined based on the first beam identifier and a first offset value.

For example, if the first beam identifier is Beam #1, in some embodiments, Beam #1 is directly used for the downlink transmission in the DL time unit, and Beam #1+K1 can be used as the beam identifier of the target beam for the downlink transmission in the SBFD time unit. The value range of K1 can be a positive integer. In this case, K1 is the first offset value. The beam field includes the index of at least one activated candidate beam. For example, the activated candidate beam is a candidate beam for the DL time unit, and the value of the beam field is m, indicating the m^{th} candidate beam among the candidate beams activated for the DL time unit in the MAC CE. Based on that the TCI-State identifier of the m^{th} candidate beam for the DL time unit in the MAC CE is the first beam identifier, i.e., Beam #1, and combined with the TCI-State for the DL time unit configured in the RRC message, the beam corresponding to the first beam identifier is determined. Based on the second beam identifier (Beam #1+K1), and combined with the TCI-State for the SBFD time unit configured in the RRC message, the beam corresponding to the second beam identifier is determined.

In some embodiments, Beam #1+K2 can be used as a downlink beam for the downlink transmission in the DL time unit, and Beam #1+K3 can be used as a downlink beam for the downlink transmission in the SBFD time unit. In some embodiments, K2 is not equal to K3, and the value ranges of K2 and K3 can be natural numbers or positive integers. K2 and K3 can be different offset values for the DL time unit and the SBFD time unit, respectively. In some embodiments, the beam field includes the index of at least one activated candidate beam. For example, the activated candidate beam is a candidate beam for the DL time unit, and the value of the beam field is m, indicating the m^{th} candidate beam among the candidate beams activated for the DL time unit in the MAC CE. Based on that the TCI-State identifier of the m^{th} candidate beam for the DL time unit in the MAC CE is the first beam identifier, i.e., Beam #1+K2, and combined with the TCI-State for the DL time unit configured in the RRC message, the beam corresponding to the first beam identifier is determined. Based on the second beam identifier (Beam #1+K3), and combined with the TCI-State for the SBFD time unit configured in the RRC message, the beam corresponding to the second beam identifier is determined.

In some embodiments, a beam indicated by the first beam identifier is at least one beam for a first reference signal, and/or a beam indicated by the first beam identifier is at least one beam for a second reference signal.

In some embodiments, a beam indicated by the first beam identifier is at least one beam for a first reference signal, and the first offset value has a first value, and/or a beam indicated by the first beam identifier is at least one beam for a second reference signal, and the first offset value has a second value.

In some embodiments of the present disclosure, the first reference signal and the second reference signal are different physical layer signals. For example, if the first reference signal is a Synchronization Signal/Physical Broadcast Channel Block (SSB), the second reference signal can include, but is not limited to, a Non-Zero Power Channel State Indication Reference Signal (NZP-CSI-RS). For another example, if the second reference signal is an SSB, the first reference signal can include, but is not limited to, an NZP-CSI-RS.

In some embodiments, the beam field also indicates a third beam identifier of at least one activated candidate beam.

A beam corresponding to a third beam identifier is used for downlink transmission in an SBFD time unit, and/or a beam corresponding to a fourth beam identifier is used for downlink transmission in a DL time unit.

The fourth beam identifier is determined based on the third beam identifier and a second offset value.

Assuming that the third beam identifier is Beam #3, then Beam #3 can directly indicate determination of the target beam for the downlink transmission in the SBFD time unit. The fourth beam identifier can be Beam #3+K4, and K4 can be the above second offset value. K4 can be any positive integer.

In some embodiments, the beam field includes an index of at least one activated candidate beam. For example, the activated candidate beam is a candidate beam for an SBFD time unit, and the value of the beam field is m, indicating the m^{th} candidate beam among the candidate beams activated for the SBFD time unit in the MAC CE. Based on that the TCI-State identifier of the m^{th} candidate beam for the SBFD time unit in the MAC CE is the third beam identifier, i.e., Beam #3, and combined with the TCI-State for the SBFD time unit configured in the RRC message, the beam corresponding to the third beam identifier is determined. Based on the fourth beam identifier (Beam #1+K4), and combined with the TCI-State for the DL time unit configured in the RRC message, the beam corresponding to the fourth beam identifier is determined.

Any of the above offset values K1 to K4 can be predefined in protocols, or configured by higher-layer signaling such as an RRC message.

In some embodiments, a beam indicated by the third beam identifier is at least one beam that transmits a third reference signal, and/or a beam indicated by the third beam identifier is at least one beam that transmits a fourth reference signal.

In some embodiments, a beam indicated by the third beam identifier is at least one beam that transmits a third reference signal, and the second offset value has a third value, and/or a beam indicated by the third beam identifier is at least one beam that transmits a fourth reference signal, and the second offset value has a fourth value.

In embodiments of the present disclosure, the third reference signal and the fourth reference signal are different physical layer signals. For example, if the third reference signal is a Synchronization Signal/Physical Broadcast Channel Block (SSB), the fourth reference signal can include, but is not limited to, a Non-Zero Power Channel State Indication Reference Signal (NZP-CSI-RS). For another example, if the fourth reference signal is an SSB, the third reference signal can include, but is not limited to, an NZP-CSI-RS.

In embodiments of the present disclosure, the beam indicated for the transmission in a DL time unit can also apply to an F time unit.

According to the technical solutions provided in embodiments of the present disclosure, the UE receives the beam indication information sent by the network device, which can be used to separately determine the beam for the transmission in the SBFD time unit. In this way, the beam indication for the SBFD time unit and other types of time units can be decoupled, so that the optimal beam can be used for the transmission in the SBFD time unit. On the one hand, the mutual interference on beams shared between the SBFD time unit and the DL time unit can be suppressed. On the other hand, the beam for the SBFD time unit can be flexibly configured, so as to use various beams as much as possible to improve the quality of the wireless communication.

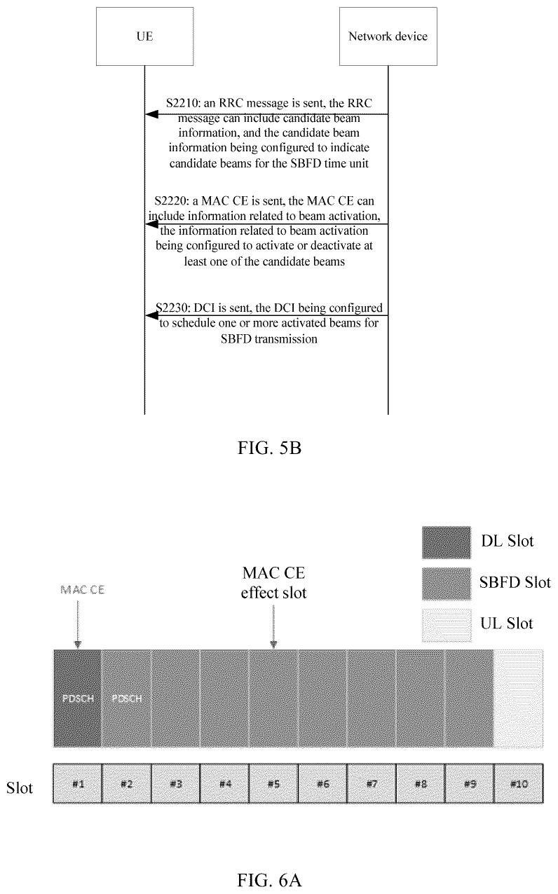

As shown in FIG. 5A, embodiments of the present disclosure provide an information processing method. The information processing method is performed by a network device, and the method includes following steps.
S2110: beam indication information is sent to a UE, the beam indication information being configured to indicate a beam for transmission in an SBFD time unit.

The network device can include, but is not limited to, an access network device. The access network device can be any access network device shown in FIG. 2.

In some embodiments, the SBFD time unit can include, but is not limited to, at least one of the following:
an SBFD slot;
an SBFD mini-slot;
an SBFD symbol;
an SBFD sub-frame;
an SBFD frame, etc.

The SBFD time unit supports both uplink and downlink transmissions of the UE. The SBFD time unit can be flexibly used based on transmission needs.

The beam indication information can be used for the UE to determine candidate beams for the uplink transmission and/or downlink transmission in the SBFD time unit, or to determine a target beam from the candidate beams. The candidate beams can be used as alternative beams for transmission in the SBFD time unit. The target beam is the beam ultimately used for transmission in the SBFD time unit. The target beam can be one or more of the candidate beams.

In some embodiments, the beam indication information includes at least one of the following:
Transmission Configuration Indicator State (TCI-State) set information, the TCI-State set information being configured to indicate a beam set, and the beam set including one or more beams;
a TCI-State identifier (ID), which indicates a beam.

In some embodiments, the TCI-State set information can include at least a TCI-State set identifier. Therefore, the beam indication information can indicate, in the form of a TCI-State set, candidate beams and/or target beams for transmission in an SBFD time unit.

The TCI-State set can include one or more TCI-States, with each TCI-State corresponding to one beam.

A TCI-State identifier can indicate one beam.

In embodiments of the present disclosure, the beam indication information sent by the network device is received, and a beam specifically used for the transmission in an SBFD time unit is determined based on the beam indication information, so as to enable the beam used for the transmission in the SBFD time unit to be different from the beam used for the transmission in the DL or UL time unit, thereby achieving the UE-to-UE CLI suppression and improving the communication quality of the SBFD time unit.

In some embodiments, the beam indication information includes at least one of the following:
candidate beam information included in an RRC message, the candidate beam information being configured to indicate the candidate beam for the SBFD time unit;
information related to beam activation included in an MAC CE, the information related to beam activation being configured to activate or deactivate at least one candidate beam;
scheduling information included in DCI, the scheduling information being configured to schedule one or more activated beams for SBFD transmission.

In some embodiments, as shown in FIG. 5B, embodiments of the present disclosure provide an information processing method, performed by a network device, and the method includes following steps.
S2210: an RRC message is sent, the RRC message can include candidate beam information, and the candidate beam information being configured to indicate candidate beams for the SBFD time unit.
S2220: an MAC CE is sent, the MAC CE can include information related to beam activation, and the information related to beam activation being configured to activate or deactivate at least one of the candidate beams.
S2230: DCI is sent, the DCI being configured to schedule one or more activated beams for SBFD transmission.

In some embodiments, the RRC message is a configuration message for candidate beams for transmission in the SBFD time unit.

The MAC CE includes information related to beam activation, which can include activation information and/or deactivation information. The activation information is configured to activate one or more candidate beams configured through the RRC message. The deactivation information can be configured to deactivate one or more activated candidate beams.

If a candidate beam is ready for use after being activated, it can be selected as the target beam for the transmission in the SBFD time unit.

Both the RRC message and the MAC CE are high-layer signaling, while the DCI is physical layer signaling, which has the characteristics of low latency. The DCI can be used to select the target beam for the transmission in the SBFD time unit from one or more candidate beams activated by the MAC CE.

In some embodiments, the number of candidate beams activated or deactivated by the MAC CE is less than or equal to the number of candidate beams configured in the RRC message.

In other embodiments, the number of target beams scheduled by the DCI is less than or equal to the number of candidate beams activated by the MAC CE.

The MAC CE includes the information related to beam activation, which can include activation information and/or deactivation information. The activation information is used to activate one or more candidate beams configured in the RRC message. The deactivation information is used to deactivate one or more activated candidate beams. The network device can send multiple MAC CEs. To update the UE's activated candidate beams, the network device can resend the MAC CE. The contents of two adjacent MAC CEs including the information related to beam activation are different.

In some embodiments, the beam indication information included in the RRC message, the MAC CE, and the DCI can be all bitmaps. Each bit in the bitmap indicates one TCI-State identifier and each TCI-State identifier corresponds to one beam.

In this case, the number of candidate beams configured by the RRC message can be determined based on the number of bits of an Information Element (IE) included in the RRC message. The number of candidate beams that can be activated or deactivated by the MAC CE can depend on the length of the MAC CE. The target beam(s) that is/are scheduled by the DCI can depend on the length of the DCI. The length of the DCI can be the number of bits contained by the DCI.

In some embodiments, the beam indication information included in the RRC message can indicate a TCI-State set, and any TCI-State in the TCI-State set corresponds to a candidate beam. By configuring candidate beams in the RRC message using a TCI-State set, the signaling overhead of the RRC message can be reduced.

The information related to candidate beam activation included in the MAC CE can also indicate a TCI-State set, a TCI-State subset, and/or a TCI-State identifier, etc.

For example, if the RRC message configures multiple TCI-State sets, the MAC CE can activate or deactivate some of the TCI-State sets using the information related to candidate beam activation. For another example, if the RRC message configures a single TCI-State set, the MAC CE can activate or deactivate a TCI-State subset using the information related to candidate beam activation. A TCI-State subset can include one or more TCI-States in the TCI-State set. If the MAC CE activates or deactivates candidate beams by including TCI-State set information or TCI-State subset information (e.g., an identifier indicating a TCI-State subset), the signaling overhead of the MAC CE can be reduced.

The DCI can include a TCI-State identifier or a beam identifier to directly indicate the target beam selected from the activated candidate beams. The DCI can include a field indicating the use of the m^{th} candidate beam. The target beam is determined based on the TCI-State identifier of the m^{th} candidate beam in the MAC CE and the TCI-State set configured in the RRC message. In this case, the value of the field included in the DCI is m.

In this way, by using the configuration through the RRC message, the activation or deactivation through the MAC CE, and scheduling through the DCI, the selection, according to needs, of appropriate transmit and/or receive beams for the communication in corresponding SBFD time units at different communication times can be achieved.

In some embodiments, both the RRC message and the MAC CE can include a single TCI-State identifier and/or a single beam identifier to implement beam configuration, activation or deactivation, and scheduling, and other beam indications for the SBFD time unit.

In some embodiments, the beam indication information included in the RRC message can indicate a TCI-State set, and any TCI-State in the TCI-State set corresponds to a candidate beam. By configuring candidate beams in the RRC message using a TCI-State set, the signaling overhead of the RRC message can be reduced.

The information related to candidate beam activation included in the MAC CE can be a bitmap indicating the candidate beams in the TCI-State set. The length of the information related to candidate beam activation included in the MAC CE is equal to the number of TCI-States in the TCI-State set. The m^{th} bit is used to indicate whether the TCI-State with a TCI-State identifier ‘m’ in the TCI-State set is a candidate beam.

The DCI can include a field indicating the use of the m^{th} candidate beam. The target beam is determined based on the TCI-State identifier of the m^{th} candidate beam in the MAC CE and the TCI-State set configured in the RRC message. In this case, the value of the field included in the DCI is m.

In some embodiments, the RRC message includes at least one of the following:
the RRC message includes first candidate beam information and second candidate beam information, the first candidate beam information being configured to indicate a candidate beam for a downlink (DL) time unit, and the second candidate beam information being configured to indicate a candidate beam for an SBFD time unit; or the RRC message includes third candidate beam information, the third candidate beam information being configured for transmission in both the DL time unit and the SBFD time unit.

In embodiments of the present disclosure, a single RRC message includes both the first candidate beam information and the second candidate beam information. The first candidate beam information indicates the candidate beam for the DL time unit, and the second candidate beam information indicates the candidate beam for the SBFD time unit. In some embodiments, a single RRC message can include two IEs, one for including the first candidate beam information and the other for including the second candidate beam information. In other embodiments, a single RRC message can include one IE including the beam indication information, with different fields of the IE being used to include the first candidate beam information and the second candidate beam information, respectively.

In some embodiments, the candidate beams configured in the RRC message can be shared candidate beams used for both the DL time unit and the SBFD time unit. In this case, the RRC message can include a single IE, and all beams indicated by the IE are candidate beams for both the DL time unit and the SBFD time unit.

In some embodiments, the IE can include, but is not limited to, a Physical Downlink Shared Channel Configuration (PDSCH-Config) IE.

In some embodiments, the TCI-State identifier included in the first candidate beam information and the TCI-State identifier included in the second candidate beam information can be the same.

In some embodiments, the TCI-State identifier included in the first candidate beam information and the TCI-State identifier included in the second candidate beam information are different.

In some embodiments, the TCI-State identifiers included in the third candidate beam information are different from each other.

The above are merely examples of the RRC message including the beam indication information, and the specific implementations are not limited to this.

In some embodiments, the number of candidate beams that can be configured by the third candidate beam information is greater than the number of candidate beams that can be configured by the first candidate beam information; and/or the number of candidate beams that can be configured by the third candidate beam information is greater than the number of candidate beams that can be configured by the second candidate beam information.

Since the DL time unit and the SBFD time unit share the same candidate beams, in order to distinguish between the DL time unit and the SBFD time unit for scheduling, the number of beams that can be configured by the third candidate beam information can be greater than the number of candidate beams that can be configured by the first candidate beam information, and/or the number of beams that can be configured by the third candidate beam information can be greater than the number of candidate beams that can be configured by the second candidate beam information.

For example, if the first candidate beam information and the second candidate beam information can configure 128 candidate beams, then the third candidate beam information can configure a number greater than 128 candidate beams. For example, the third candidate beam information can configure 256 candidate beams.

That is, in the present disclosure, candidate beams can be configured for both the SBFD time unit and the DL time unit simultaneously using a single RRC message, resulting in a reduced number of RRC messages and signaling overhead.

In some embodiments, the information related to beam activation includes:
first information related to the beam activation included in a first field of the MAC CE, the first information being configured to activate or deactivate at least one candidate beam for the DL time unit;
second information related to the beam activation included in a second field of the MAC CE, the second information being configured to activate or deactivate at least one candidate beam for the SBFD time unit.

In some embodiments, a single MAC CE can include activation or deactivation information for candidate beams for both SBFD and DL time units.

Specifically, in embodiments of the present disclosure, a single MAC CE can include two independent fields, one for including the first information and the other one for including the second information. The first information can be used to activate or deactivate the candidate beams for the DL time unit, and the second information can be used to activate or deactivate the candidate beams for the SBFD time unit. Both the first information and the second information can be represented through a bitmap, and two bit values of any bit in the bitmap can represent activation or deactivation, respectively.

In some other embodiments, the MAC CE used for activating or deactivating candidate beams for the transmission in the DL time unit is different from the MAC CE used for activating or deactivating candidate beams for the SBFD time unit.

The activation or deactivation of candidate beams for the SBFD time unit and the DL time unit are achieved using two MAC CEs, which allows for flexible activation or deactivation of candidate beams for SBFD and DL time units using different MAC CEs, depending on the transmission requirements of SBFD and DL time units, as well as channel conditions, etc.

If two MAC CEs are used to activate or deactivate candidate beams for the SBFD time unit and the DL time unit, respectively, the transmission resources for these two MAC CEs can be different. The transmission resources can be frequency domain resources and/or time domain resources.

In some embodiments, the MAC CEs for the SBFD time unit and the DL time unit can include MAC CEs sent at different time points. A period after sending the first MAC CE, the network device can update the UE's activated candidate beams for the DL time unit and/or the SBFD time unit by sending a second MAC CE.

In some embodiments, the MAC CE used for activating or deactivating the candidate beams for the SBFD time unit is transmitted in the SBFD time unit, and/or the MAC CE used for activating or deactivating the candidate beams for the DL time unit is transmitted in the DL time unit.

In this case, if the network device needs to send a MAC CE used for activating or deactivating candidate beams for the SBFD time unit, the MAC CE can be configured in the SBFD time unit. If the network device needs to send a MAC CE used for activating or deactivating candidate beams for the DL time unit, the MAC CE can be configured in the DL time unit. In this way, if the UE receives a MAC CE in an SBFD time unit, it can determine that the MAC CE indicates the activation or deactivation of the candidate beams for the SBFD time unit. If the UE receives a MAC CE in a DL time unit, it can determine that the MAC CE indicates the activation or deactivation of the candidate beams for the DL time unit.

In some embodiments, the bits of the MAC CE include first-category bits and second-category bits. The first-category bits are high-order bits relative to the second-category bits, or the second-category bits are high-order bits relative to the first-category bits.

The first-category bits include the first information, and/or the second-category bits include the second information.

In some embodiments of the present disclosure, a single MAC CE is used to include the information related to candidate beam activation for both the SBFD time unit and the DL time unit.

In some embodiments of the present disclosure, all bits of the MAC CE are divided into first-category bits and second-category bits. The first-category bits include the first information, and the second-category bits include the second information.

For example, an MAC CE can include 16 bytes, for a total of 128 bits. The first-category bits can be a continuously distributed portion of the 128 bits. Similarly, the second-category bits can also be a continuously distributed portion of the 128 bits. The number of the first-category bits and the number of the second-category bits can be the same or different.

Assuming that a MAC CE includes 128 bits, and the first-category bits and the second-category bits divide the 128 bits equally. The first-category bits and the second-category bits each occupy 64 bits. For example, if the first-category bits are high-order 64 bits of the 128 bits, then the second-category bits are low-order 64 bits of the 128 bits. In this case, the first-category bits are high-order bits relative to the second-category bits. For another example, if the first-category bits are low-order 64 bits of the 128 bits, then the second-category bits are high-order 64 bits of the 128 bits. In this case, the first-category bits are low-order bits relative to the second-category bits.

In some embodiments, the MAC CE further includes an indication bit, and the indication bit is configured to indicate whether the information related to beam activation contained in the MAC CE is for an SBFD time unit or a DL time unit.

The MAC CEs for the SBFD time unit and the DL time unit are different, and the MAC CEs can include an indication bit indicating whether the current MAC CE is for an SBFD time unit or for a DL time unit. The indication bit can include one or more bits.

In this case, the MAC CE for a DL time unit is not limited to being transmitted in the DL time unit, and similarly, the MAC CE for an SBFD time unit is not limited to being transmitted in the SBFD time unit.

Scheduling information for the SBFD time unit and the DL time unit can be included in the same DCI or in different DCI.

If the scheduling information for the SBFD time unit and the DL time unit is included in different DCI, the transmission resources for the two DCI can be different. The transmission resources can include, but are not limited to, time domain resources.

In some embodiments, if the downlink transmission scheduled by the DCI is in an SBFD time unit, the scheduling information is further configured to indicate that at least one activated candidate beam for the SBFD time unit is used for transmission in the SBFD time unit, and/or if the downlink transmission scheduled by the DCI is in a DL time unit, the scheduling information is further configured to indicate that at least one activated candidate beam for the DL time unit is used for transmission in the DL time unit. In this way, if the DCI-scheduled downlink transmission received by the UE is located in the DL time unit, the activated beam indicated by the scheduling information included by the DCI can be the target beam for transmission in the DL time unit. If the DCI-scheduled downlink transmission received by the UE is located in the SBFD time unit, the activated beam indicated by the scheduling information included by the DCI can be the target beam for transmission in the SBFD time unit.

In some embodiments, the scheduling information includes a beam field.

The beam field is configured to indicate that at least one activated candidate beam is scheduled.

The activated candidate beam is a candidate beam for the SBFD time unit or a candidate beam for the DL time unit. The scheduling information can include a beam field, which can include an index of at least one activated candidate beam. For example, the activated candidate beam is a candidate beam for the SBFD time unit, and the value of the beam field is m, indicating the m^{th} candidate beam among the candidate beams activated for the SBFD time unit in the MAC CE. The target beam is determined based on the TCI-State identifier of the m^{th} candidate beam for the SBFD time unit in the MAC CE and the TCI-State for the SBFD time unit configured in the RRC message.

That is, the beam indicated by the beam field of the scheduling information is the target beam scheduled for transmission in the DL time unit or transmission in the SBFD time unit.

It should be noted that in embodiments of the present disclosure, the candidate beams configured for the DL time unit can also be candidate beams for the F time unit, and/or the candidate beams activated for the DL time unit can also be candidate beams for the F time unit, and/or the beams scheduled for the transmission in the DL time unit can also be used for the transmission in the F time unit.

In some embodiments of the present disclosure, the downlink transmission includes but is not limited to PDSCH and/or PDCCH transmission.

In some embodiments, the scheduling information can also include a scheduling instruction, which indicates to perform the PDSCH transmission or the PDCCH transmission, or over which PDSCH and/or PDCCH to perform downlink transmission, etc.

In some embodiments, the beam field indicates at least one activated candidate beam. In some embodiments, the beam field includes a first beam identifier of at least one candidate beam.

A beam corresponding to a first beam identifier is used for downlink transmission in a DL time unit, and/or a beam corresponding to a second beam identifier is used for downlink transmission in an SBFD time unit.

The second beam identifier is determined based on the first beam identifier and a first offset value.

For example, if the first beam identifier is Beam #1, in some embodiments, Beam #1 is directly used for the downlink transmission in the DL time unit, and Beam #1+K1 can be used as the beam identifier of the target beam for the downlink transmission in the SBFD time unit. The value range of K1 can be a positive integer. In this case, K1 is the first offset value.

The beam field includes the index of at least one activated candidate beam. For example, the activated candidate beam is a candidate beam for the DL time unit, and the value of the beam field is m, indicating the m^{th} candidate beam among the candidate beams activated for the DL time unit in the MAC CE. Based on that the TCI-State identifier of the m^{th} candidate beam for the DL time unit in the MAC CE is the first beam identifier, i.e., Beam #1, and combined with the TCI-State for the DL time unit configured in the RRC message, the beam corresponding to the first beam identifier is determined. Based on the second beam identifier (Beam #1+K1), and combined with the TCI-State for the SBFD time unit configured in the RRC message, the beam corresponding to the second beam identifier is determined.

In some embodiments, Beam #1+K2 can be used as a downlink beam for the downlink transmission in the DL time unit, and Beam #1+K3 can be used as a downlink beam for the downlink transmission in the SBFD time unit. In some embodiments, K2 is not equal to K3, and the value ranges of K2 and K3 can be natural numbers or positive integers. K2 and K3 can be different offset values for the DL time unit and the SBFD time unit, respectively.

In some embodiments, the beam field includes the index of at least one activated candidate beam. For example, the activated candidate beam is a candidate beam for the DL time unit, and the value of the beam field is m, indicating the m^{th} candidate beam among the candidate beams activated for the DL time unit in the MAC CE. Based on that the TCI-State identifier of the m^{th} candidate beam for the DL time unit in the MAC CE is the first beam identifier, i.e., Beam #1+K2, and combined with the TCI-State for the DL time unit configured in the RRC message, the beam corresponding to the first beam identifier is determined. Based on the second beam identifier (Beam #1+K3), and combined with the TCI-State for the SBFD time unit configured in the RRC message, the beam corresponding to the second beam identifier is determined.

In some embodiments, a beam indicated by the first beam identifier is at least one beam for a first reference signal, and/or a beam indicated by the first beam identifier is at least one beam for a second reference signal.

In some embodiments, a beam indicated by the first beam identifier is at least one beam for a first reference signal, and the first offset value has a first value, and/or a beam indicated by the first beam identifier is at least one beam for a second reference signal, and the first offset value has a second value.

In some embodiments of the present disclosure, the first reference signal and the second reference signal are different physical layer signals. For example, if the first reference signal is a Synchronization Signal/Physical Broadcast Channel Block (SSB), the second reference signal can include, but is not limited to, a Non-Zero Power Channel State Indication Reference Signal (NZP-CSI-RS). For another example, if the second reference signal is an SSB, the first reference signal can include, but is not limited to, an NZP-CSI-RS.

In some embodiments, the beam field also indicates a third beam identifier of at least one activated candidate beam. In some embodiments, the beam field includes the third beam identifier of the at least one activated candidate beam.

A beam corresponding to a third beam identifier is used for downlink transmission in an SBFD time unit, and/or a beam corresponding to a fourth beam identifier is used for downlink transmission in a DL time unit.

The fourth beam identifier is determined based on the third beam identifier and a second offset value.

Assuming that the third beam identifier is Beam #3, then Beam #3 can directly indicate determination of the target beam for the downlink transmission in the SBFD time unit. The fourth beam identifier can be Beam #3+K4, and K4 can be the above second offset value. K4 can be any positive integer.

In some embodiments, the beam field includes an index of at least one activated candidate beam. For example, the activated candidate beam is a candidate beam for an SBFD time unit, and the value of the beam field is m, indicating the m^{th} candidate beam among the candidate beams activated for the SBFD time unit in the MAC CE. Based on that the TCI-State identifier of the m^{th} candidate beam for the SBFD time unit in the MAC CE is the third beam identifier, i.e., Beam #3, and combined with the TCI-State for the SBFD time unit configured in the RRC message, the beam corresponding to the third beam identifier is determined. Based on the fourth beam identifier (Beam #1+K4), and combined with the TCI-State for the DL time unit configured in the RRC message, the beam corresponding to the fourth beam identifier is determined.

Any of the above offset values K1 to K4 can be predefined in protocols, or configured by higher-layer signaling such as an RRC message.

In some embodiments, a beam indicated by the third beam identifier is at least one beam that transmits a third reference signal, and/or a beam indicated by the third beam identifier is at least one beam that transmits a fourth reference signal.

In some embodiments, a beam indicated by the third beam identifier is at least one beam that transmits a third reference signal, and the second offset value has a third value, and/or a beam indicated by the third beam identifier is at least one beam that transmits a fourth reference signal, and the second offset value has a fourth value.

In embodiments of the present disclosure, the third reference signal and the fourth reference signal are different physical layer signals. For example, if the third reference signal is a Synchronization Signal/Physical Broadcast Channel Block (SSB), the fourth reference signal can include, but is not limited to, a Non-Zero Power Channel State Indication Reference Signal (NZP-CSI-RS). For another example, if the fourth reference signal is an SSB, the third reference signal can include, but is not limited to, an NZP-CSI-RS.

That the RRC message configures beams for PDSCH and that the MAC CE activates beams for PDSCH can include following steps.
Step 1: multiple TCI-States to be used by PDSCH is configured through an RRC message.

In some embodiments, tci-StatesToAddModList SEQUENCE (SIZE (1 . . . maxNrofTCIStates)) OF TCI-State is configured in a PDSCH-Config information element, where a value of maxNrofTCI-StatesPDSCH is 128. The maxNrofTCI-StatesPDSCH can represent a maximum of 128 candidate beams supported by the PDSCH.

The TCI-State includes a TCI-State identifier (TCI-StateId), which also includes an SSB index or an identifier of the Non-Zero Power Channel State Indication Reference Signal (NZP-CSI-RS), namely NZP-CSI-RS-ResourceId. It is assumed that N TCI-States are configured.
Step 2: beams corresponding to M TCI-States are activated through a MAC CE using a variable length.
   5 bits are used to indicate a serving cell ID.
   2 bits are used to indicate a Band Width Part ID (BWP ID).
   N bits are used to activate the M TCI-States. The RRC message configures N TCI-States for the Physical Downlink Shared Channel (PDSCH). A bitmap is used to activate beams corresponding to M (M≤8) TCI-States from the N TCI-States (bitmap value being 1). Specifically, a value of the n^{th} bit in the bitmap being 1 indicates that the candidate beam with a TCI-State ID ‘n’ is activated.
Step 3: the TCI field (3 bits) in Downlink Control Information Format 1-1 (DCI format 1-1) is used to indicate the TCI-State to be used among M (≤8) activated TCI-States. The target beam to be used by the PDSCH is determined based on the SSB or NZP-CSI-RS resource corresponding to that TCI-State. Specifically, the TCI field in DCI format 1-1 indicates an index of at least one activated candidate beam, for example, indicating the m^{th} activated TCI-State, which means that the m^{th} activated TCI-State (index m) among the candidate beams activated in the MAC CE is activated. Based on the TCI-State identifier corresponding to the m^{th} activated TCI-State and the TCI-State information configured in the RRC message, the target beam, which is to be used by the PDSCH, scheduled by DCI is determined.

For example, the value of the 4^{th}, 5^{th}, 6^{th}, 7^{th}, 8^{th}, 9^{th}, 10^{th}, and 11^{th} bits in the bitmap in the MAC CE is 1, which means that the candidate beams with TCI-State identifiers of 4, 5, 6, 7, 8, 9, 10, and 11 in the N TCI-States, which are to be used by the PDSCH, configured in the RRC message are activated. The activated candidate beams with TCI-State identifiers of 4, 5, 6, 7, 8, 9, 10, and 11 are indexed from small to large according to the TCI-State identifiers, then the beam index values of these activated beams are 0, 1, 2, 3, 4, 5, 6, and 7. It can be understood that the index values of the activated beams with TCI-State identifiers of 4, 5, 6, 7, 8, 9, 10, and 11 are 0, 1, 2, 3, 4, 5, 6, and 7, respectively.

| | | | | | | | | | | | | | | | | | | |
|---|---|---|---|---|---|---|---|---|---|---|---|---|---|---|---|---|---|---|
| Step | TCI- | 0 | 1 | 2 | 3 | 4 | 5 | 6 | 7 | 8 | 9 | 10 | 11 | 12 | 13 | 14 | . . . | N |
| 1 | State | | | | | | | | | | | | | | | | | |
| | ID | | | | | | | | | | | | | | | | | |
| Step | MAC | 0 | 0 | 0 | 0 | 1 | 1 | 1 | 1 | 1 | 1 | 1 | 1 | 0 | 0 | 0 | . . . | 0 |
| 2 | CE | | | | | | | | | | | | | | | | | |
| Step | Index | — | — | — | — | 0 | 1 | 2 | 3 | 4 | 5 | 6 | 7 | — | — | — | — | — |
| 3 | | | | | | | | | | | | | | | | | | |

Given that there are different numbers of Tx Chains in DL and SBFD slots, the optimal beams may differ, and thus different NZP-CSI-RS resources or SSBs are required for Beam Management. In this case, the TCI-State identifiers corresponding to the optimal beams in DL and SBFD slots differ from each other.
In the case where DL and SBFD slots may have the same optimal beams but different NZP-CSI-RS resources or SSBs, the NZP-CSI-RS resources or SSB indices differ, resulting in different TCI-State identifiers for DL and SBFD slots.
In the case where DL and SBFD slots have different optimal beams, resulting in different TCI-State identifiers corresponding thereto.

Therefore, the beams activated for the transmission in DL and SBFD slots need to be indicated separately. When the TCI-State set activated by the MAC CE is used for PDSCH transmission, it will be delayed to go into effect.

The MAC CE used to activate or deactivate the TCI-States can be transmitted over the PDSCH. The Hybrid Automatic Repeat-Request Acknowledgement (HARQ-ACK) corresponding to the PDSCH is sent in slot n, while the beam corresponding to the TCI-State flag activated by the MAC CE goes into effect starting from slot

$$n + 3 {N}_{slot}^{subframe , μ} + \frac{{2}^{μ}}{{2}^{{μ}_{{K}_{mac}}}} \cdot {k}_{mac} ,$$

where

$${N}_{slot}^{subframe , μ} = {2}^{μ}$$

represents the number of slots contained in a sub-frame (1 ms) when the Subcarrier Spacing (SCS) value is u. For example, if μ=0,

$${N}_{slot}^{subframe , μ} = 1.$$

When the SCS is 15 kHz, μ=0. If the SCS is not 15 kHz, μ=SCS/15 kHz−1.

In some embodiments, u represents the Subcarrier Spacing configuration of the PUCCH carrying the HARQ-ACK.

μ_{K}_{_{mac}} is the Subcarrier Spacing configuration of k_{mac}. Within the Frequency Range (FR) 1, the value of μ_{K}_{_{mac}} is 0.

The value of k_{mac} can be indicated through the information element K-Mac in the RRC message. If the information element K-Mac is not configured in the RRC message, the value of k_{mac} is 0.

The TCI-States for the PDSCH transmission activated by the MAC CE are delayed to go into effect, and thus the TCI-States indicated for DL and SBFD slots cannot be used in corresponding DL and SBFD slots.

### Example

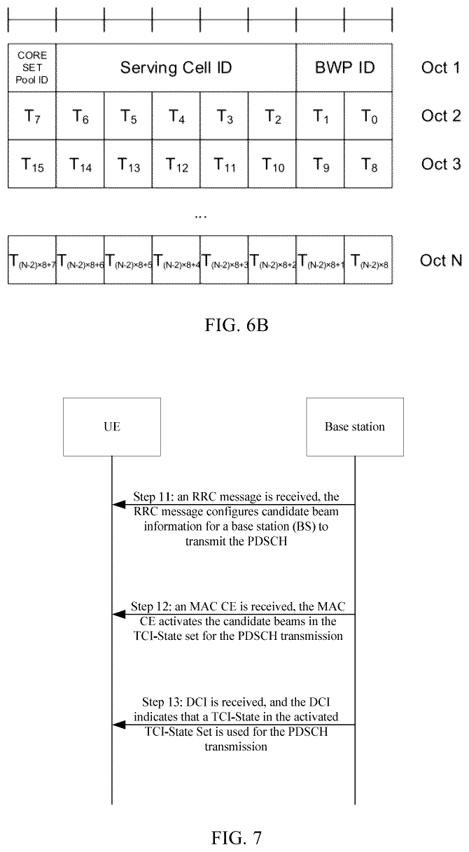

As shown in FIG. 6A, the optimal beams for Slot #1, as well as Slot #2 to Slot #9 correspond to different TCI-States. That is, the optimal Beam #a used in Slot #1 and the optimal Beam #b used in Slot #2 are different.

Slot #1 uses an activated Beam Set #A, which does not include Beam #b.

The MAC CE in Slot #1 indicates an activated Beam Set #B for the PDSCH in SBFD slots. The activated Beam Set #B includes the optimal Beam #b. The MAC CE goes into effect in Slot #5. Therefore, optimal Beam #b cannot be used for the PDSCH in Slots #2, #3, and #4.

FIG. 6B shows a schematic diagram of an MAC CE. One “Oct” represents one byte. The CORESET ID in FIG. 6B is used to identify the CORESET. Frequency domain resources for the PDCCH are configured in the CORESET.

As shown in FIG. 7, embodiments of the present disclosure provide an information processing method, which includes following steps.
Step 11: an RRC message is received. The RRC message configures candidate beam information for a base station (BS) to transmit the PDSCH. Step 11 can be implemented in following embodiments.
Scheme 1-1: two sets of candidate beam information are configured in the RRC message. These two sets of candidate beam information are configuration information for candidate beams for the DL slot and candidate beams for the SBFD slot, respectively.

In some embodiments, a new information element, TCI-State-SBFD, is added to the RRC message to configure the TCI-State information for the SBFD slot. The TCI-StateId in the TCI-State-SBFD can be the same as the TCI-StateId in the TCI-State. For the same TCI-StateId, the SSB-index or NZP-CSI-RS-resourceId corresponding to the TCI-StateId in the TCI-State-SBFD can be different from that in the TCI-State.

In some embodiments, the TCI-State identifier in the TCI-State-SBFD can be different from the TCI-State identifier in the TCI-State.
Scheme 1-2: only one set of candidate beam information is configured in the RRC message. The TCI-State configures the TCI-State information for the DL slot.

In some embodiments, the maximum number of candidate beams (maxNrofTCI-States) provided in the RRC message is increased. The maxNrofTCI-States can be a maximum number of candidate beams configured in the RRC message.
Step 12: an MAC CE is received. The MAC CE activates the candidate beams in the TCI-State set for the PDSCH transmission.
Step 12 can be implemented in following embodiments.
Scheme 2-1: one MAC CE simultaneously activates TCI-State Set #1 and TCI-State Set #2. TCI-State Set #1 includes M1 (≤8) TCI-States, and TCI-State Set #2 includes M2 (≤8) TCI-States. TCI-State Set #1 and TCI-State Set #2 are used for DL slots and SBFD slots, respectively.
Scheme 2-1 can be implemented in following embodiments.
Scheme 2-1-1: a field is added to the MAC CE to activate TCI-State Set #2 for SBFD slots. For example, N bits are added to the MAC CE to activate TCI-State Set #2 for SBFD slots, where N optionally takes the value of 64 or 128.
Scheme 2-2: two MAC CEs are used to activate TCI-State Set #1 and TCI-State Set #2 for DL and SBFD slots, respectively. The MAC CE indicates the beam corresponding to TCI-State Id #1.
Scheme 2-2 can be implemented in following embodiments.
Scheme 2-2-1: one bit is added to the MAC CE to indicate whether the MAC CE is for DL or SBFD slots.

For example, if the value of the added bit is 1, it indicates that the MAC CE is for the DL slot, and if the value of the added bit is 0, it indicates that the MAC CE is for the SBFD slot.
Scheme 2-2-2: interpretation of the information included in the MAC CE is updated, which can include but is not limited to:
if the MAC CE is transmitted in the DL slot, the MAC CE is used to activate TCI-State Set #1 for DL slots;
if the MAC CE is transmitted in the SBFD slot, the MAC CE is used to activate TCI-State Set #2 for SBFD slots.
Scheme 2-3: the MAC CE in the related art activates TCI-State Set #1.
Step 13: DCI is received. An indicated TCI-State in the activated TCI-State Set is used for the PDSCH transmission.
Step 13 can be implemented in following embodiments.
Scheme 3-1: if the PDSCH indicated by the DCI is in the DL slot, the DCI indicates that a TCI-State in TCI-State Set #1 is used for the PDSCH transmission. if the PDSCH indicated by the DCI is in the SBFD slot, the DCI indicates that a TCI-State in TCI-State Set #2 is used for the PDSCH transmission.
Scheme 3-2: the DCI indicates the beam corresponding to TCI-State Id #1 in TCI-State Set #1, and the PDSCH scheduled by the DCI is in Slot m.

The reference signal corresponding to TCI-State Id #1 is the NZP-CSI-RS.

If Slot m is a DL slot, the DCI indicates that the DL slot uses the beam corresponding to TCI-State Id #1.

If Slot m is an SBFD slot, the DCI indicates that the SBFD slot uses the beam corresponding to TCI-State Id #1+K1.

In some embodiments, K1 is configured through the RRC message or is a default value.

The reference signal corresponding to TCI-State Id #1 is the SSB.

If Slot m is a DL slot, the DCI indicates that the DL slot uses the beam corresponding to TCI-State Id #1.

If Slot m is an SBFD slot, the DCI indicates that the SBFD slot uses the beam corresponding to TCI-State Id #1+K2.

Option 2-3-1: K2 is not equal to K1, and K2 is configured through the RRC message.

Option 2-3-2: K2 is equal to 0.

Option 2-3-3: K2=K1.

In some embodiments, one of Options 2-3-2 and 2-3-3 is used as a default approach, and the default approach will be used when K2 is not configured.
Step 14: the target beam used by the PDSCH in DL and SBFD slots is determined according to Steps 11, 12, and 13.

The information processing method provided in embodiments of the present disclosure can include:
Scheme 1-1 or 1-2 of Step 11;
Scheme 2-1 or 2-2 of Step 12;
Scheme 3-1 of Step 13.

The information processing method provided in embodiments of the present disclosure can include:
Scheme 1-1 or 1-2 of Step 11;
Scheme 2-3 of Step 12;
Scheme 3-2 of Step 13.

When a UE receives one MAC CE, with both TCI-State Set #1 and TCI-State Set #2 being activated, an information element is added to the MAC CE, which is used to indicate the two activated TCI-State sets, respectively.

One MAC CE is received to activate TCI-State Set #1 for a DL slot or TCI-State Set #2 for an SBFD slot, one bit is added to the MAC CE, whether the MAC CE is used for the DL slot or the SBFD slot is indicated explicitly, or whether the MAC CE is used for the DL slot or the SBFD slot is determined based on a slot type in which the MAC CE is located.

If the PDSCH indicated by the DCI is in a DL slot, the DCI indicates that a TCI-State in TCI-State Set #1 is used for the PDSCH transmission in the DL slot. If the PDSCH indicated by the DCI is in an SBFD slot, the DCI indicates that a TCI-State in TCI-State Set #2 is used for PDSCH transmission in the SBFD slot.

The RRC message is received to configure offset values K1 and K2, and one DCI is received. Based on the beam indicated by the DCI for the PDSCH transmission, as well as K1 and K2, the optimal beams for the PDSCH in both DL and SBFD slots are determined.

K1 is a default value or a configured value.

K2 is a default value or a configured value.

The default value can be a default value predetermined based on a protocol or other means. The configured value can be indicated through an RRC message.

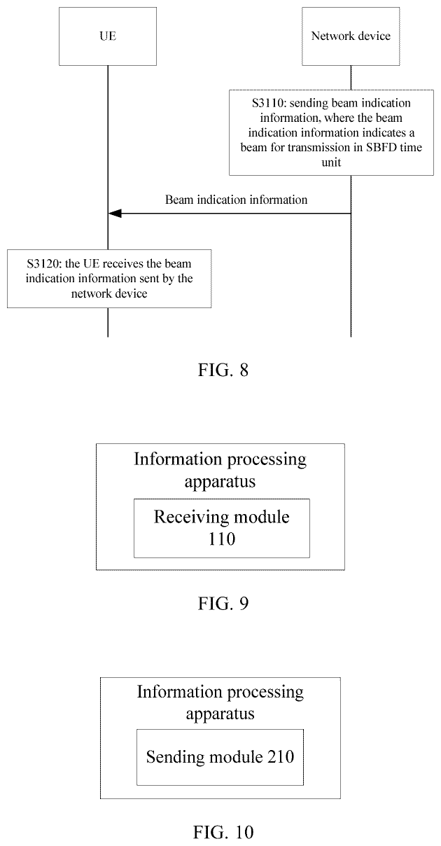

As shown in FIG. 8, embodiments of the present disclosure provide an information processing method. The method includes following steps.
S3110: a network device sends beam indication information to a user equipment (UE), the beam indication information being configured to indicate a beam for transmission in a Sub Band Full Duplex (SBFD) time unit.
S3120: the UE receives the beam indication information sent by the network device.

The information processing method can be performed by a communication system. The communication system can include a network device and a UE, which can wirelessly communicate with each other. The network device can include, but is not limited to, an access network device. The access network device can be various types of base stations.

In some embodiments, the beam indication information includes at least one of the following:
candidate beam information included in a Radio Resource Control (RRC) message, the candidate beam information being configured to indicate the candidate beam for the SBFD time unit;
information related to beam activation included in a Media Access Control (MAC) Control Element (CE), the information related to beam activation being configured to activate or deactivate at least one candidate beam;
scheduling information included in Downlink Control Information (DCI), the scheduling information being configured to schedule one or more activated beams for SBFD transmission.

As shown in FIG. 9, embodiments of the present disclosure provide an information processing apparatus. The information processing apparatus includes a receiving module 110.

The receiving module 110 is configured to receive beam indication information sent by a network device, the beam indication information being configured to indicate a beam for transmission in a Sub Band Full Duplex (SBFD) time unit.

The information processing apparatus can be a UE. The information processing apparatus can further include a storage module, which can at least be configured to store the beam indication information.

The information processing apparatus can further include a processing module, which can include, but is not limited to, various types of processors.

It should be understood that the beam indication information includes at least one of the following:
candidate beam information included in a Radio Resource Control (RRC) message, the candidate beam information being configured to indicate the candidate beam for the SBFD time unit;
information related to beam activation included in a Media Access Control (MAC) Control Element (CE), the information related to beam activation being configured to activate or deactivate at least one candidate beam;
scheduling information included in Downlink Control Information (DCI), the scheduling information being configured to schedule one or more activated beams for SBFD transmission. It should be understood that the RRC message includes at least one of the following:
first candidate beam information and second candidate beam information included in the RRC message, the first candidate beam information being configured to indicate a candidate beam for a downlink (DL) time unit, and the second candidate beam information being configured to indicate the candidate beam for the SBFD time unit; or
third candidate beam information included in the RRC message, the third candidate beam information being configured for transmission in both the DL time unit and the SBFD time unit.

It should be understood that the number of candidate beams that can be configured by the third candidate beam information is greater than the number of candidate beams that can be configured by the first candidate beam information; and/or,
the number of candidate beams that can be configured by the third candidate beam information is greater than the number of candidate beams that can be configured by the second candidate beam information.

It should be understood that the information related to the beam activation includes:
first information related to the beam activation included in a first field of the MAC CE, the first information being configured to activate or deactivate at least one candidate beam for a DL time unit; and
second information related to the beam activation included in a second field of the MAC CE, the second information being configured to activate or deactivate at least one candidate beam for the SBFD time unit.

It should be understood that the MAC CE used to activate or deactivate the candidate beam for the DL time unit is different from the MAC CE used to activate or deactivate the candidate beam for the SBFD time unit.

It should be understood that an MAC CE used to activate or deactivate the candidate beam for the SBFD time unit is transmitted in the SBFD time unit; and/or an MAC CE used to activate or deactivate the candidate beam for a DL time unit is transmitted in the DL time unit.

It should be understood that bits of the MAC CE include a first-category bit and a second-category bit;
the first-category bit is a high-order bit relative to the second-category bit, or the second-category bit is the high-order bit relative to the first-category bit;
the first-category bit includes first information, and/or the second-category bit includes second information.

It should be understood that the MAC CE further includes an indication bit, and the indication bit is configured to indicate whether the information related to the beam activation included in the MAC CE is for the SBFD time unit or the DL time unit.

It should be understood that downlink transmission scheduled by the DCI is located in the SBFD time unit, and the scheduling information is further configured to indicate that at least one activated candidate beam is used for transmission in the SBFD time unit; and/or
the downlink transmission scheduled by the DCI is located in the DL time unit, and the scheduling information is further configured to indicate that the at least one activated candidate beam is used for transmission in the DL time unit.

It should be understood that downlink transmission scheduled by the DCI is located in the SBFD time unit, and the scheduling information is further configured to indicate that at least one activated candidate beam for the SBFD time unit is used for the transmission in the SBFD time unit; and/or
the downlink transmission scheduled by the DCI is located in the DL time unit, and the scheduling information is further configured to indicate that the at least one activated candidate beam for the DL time unit is used for the transmission in the DL time unit.

It should be understood that the scheduling information includes a beam field, and the beam field is configured to indicate that at least one activated candidate beam is scheduled.

It should be understood that the beam field indicates a first beam identifier of the at least one activated candidate beam;
a beam corresponding to the first beam identifier is used for downlink transmission in the DL time unit, and/or a beam corresponding to a second beam identifier is used for downlink transmission in the SBFD time unit; and
the second beam identifier is determined based on the first beam identifier and a first offset value.

It should be understood that a beam corresponding to the first beam identifier is at least one beam for a first reference signal; and/or a beam corresponding to the first beam identifier is at least one beam for a second reference signal.

It should be understood that a beam corresponding to the first beam identifier is at least one beam for a first reference signal, and the first offset value has a first value; and/or
a beam corresponding to the first beam identifier is at least one beam for a second reference signal, and the first offset value has a second value.

It should be understood that the beam field further includes a third beam identifier of at least one activated candidate beam;
a beam corresponding to the third beam identifier is used for the downlink transmission in the SBFD time unit; and/or a beam corresponding to a fourth beam identifier is used for the downlink transmission in the DL time unit; and
the fourth beam identifier is determined based on the third beam identifier and a second offset value.

In some embodiments, a beam corresponding to the third beam identifier is at least one beam that transmits a third reference signal; and/or a beam corresponding to the third beam identifier is at least one beam that transmits a fourth reference signal.

It can be understood that a beam corresponding to the third beam identifier is at least one beam that transmits a third reference signal, and the second offset value has a third value; and/or
a beam corresponding to the third beam identifier is at least one beam that transmits a fourth reference signal, and the second offset value has a fourth value.

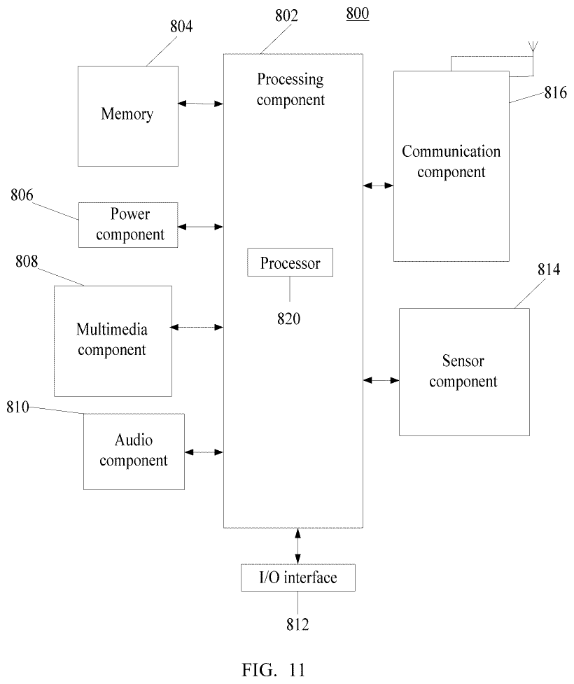

As shown in FIG. 10, embodiments of the present disclosure provide an information processing apparatus. The information processing apparatus includes a sending module 210.

The sending module 210 is configured to send beam indication information to a user equipment (UE), the beam indication information being configured to indicate a beam for transmission in a Sub Band Full Duplex (SBFD) time unit.

The information processing apparatus can be a network device.

In some embodiments, the information processing apparatus can further include a storage module configured to store the beam indication information.

In some embodiments, the information processing apparatus can further include a processing module configured to process the beam indication information, for example, to determine candidate beams, activated candidate beams, and/or target beams based on the beam indication information.

It should be understood that the beam indication information includes at least one of the following:
candidate beam information included in a Radio Resource Control (RRC) message, the candidate beam information being configured to indicate the candidate beam for the SBFD time unit;
information related to beam activation included in a Media Access Control (MAC) Control Element (CE), the information related to beam activation being configured to activate or deactivate at least one candidate beam;
scheduling information included in Downlink Control Information (DCI), the scheduling information being configured to schedule one or more activated beams for SBFD transmission.

It should be understood that the RRC message includes at least one of the following:
first candidate beam information and second candidate beam information included in the RRC message, the first candidate beam information being configured to indicate a candidate beam for a downlink (DL) time unit, and the second candidate beam information being configured to indicate the candidate beam for the SBFD time unit; or
third candidate beam information included in the RRC message, the third candidate beam information being configured for transmission in both the DL time unit and the SBFD time unit.

It should be understood that the number of candidate beams that can be configured by the third candidate beam information is greater than the number of candidate beams that can be configured by the first candidate beam information; and/or,
the number of candidate beams that can be configured by the third candidate beam information is greater than the number of candidate beams that can be configured by the second candidate beam information.

It should be understood that the information related to the beam activation includes:
first information related to the beam activation included in a first field of the MAC CE, the first information being configured to activate or deactivate at least one candidate beam for a DL time unit; and
second information related to the beam activation included in a second field of the MAC CE, the second information being configured to activate or deactivate at least one candidate beam for the SBFD time unit.

It should be understood that the MAC CE used to activate or deactivate the candidate beam for the DL time unit is different from the MAC CE used to activate or deactivate the candidate beam for the SBFD time unit.

It should be understood that an MAC CE used to activate or deactivate the candidate beam for the SBFD time unit is transmitted in the SBFD time unit; and/or
an MAC CE used to activate or deactivate the candidate beam for a DL time unit is transmitted in the DL time unit.

It should be understood that bits of the MAC CE include a first-category bit and a second-category bit;
the first-category bit is a high-order bit relative to the second-category bit, or the second-category bit is the high-order bit relative to the first-category bit;
the first-category bit includes first information, and/or the second-category bit includes second information.

It should be understood that the MAC CE further includes an indication bit, and the indication bit is configured to indicate whether the information related to the beam activation included in the MAC CE is for the SBFD time unit or the DL time unit.

It should be understood that downlink transmission scheduled by the DCI is located in the SBFD time unit, and the scheduling information is further configured to indicate that at least one activated candidate beam is used for transmission in the SBFD time unit; and/or
the downlink transmission scheduled by the DCI is located in the DL time unit, and the scheduling information is further configured to indicate that the at least one activated candidate beam is used for transmission in the DL time unit.

It should be understood that downlink transmission scheduled by the DCI is located in the SBFD time unit, and the scheduling information is further configured to indicate that at least one activated candidate beam for the SBFD time unit is used for the transmission in the SBFD time unit; and/or
the downlink transmission scheduled by the DCI is located in the DL time unit, and the scheduling information is further configured to indicate that the at least one activated candidate beam for the DL time unit is used for the transmission in the DL time unit.

It should be understood that the scheduling information includes a beam field, and the beam field is configured to indicate that at least one activated candidate beam is scheduled.

It should be understood that the beam field indicates a first beam identifier of the at least one activated candidate beam;
a beam corresponding to the first beam identifier is used for downlink transmission in the DL time unit, and/or a beam corresponding to a second beam identifier is used for downlink transmission in the SBFD time unit; and
the second beam identifier is determined based on the first beam identifier and a first offset value.

It should be understood that a beam corresponding to the first beam identifier is at least one beam for a first reference signal; and/or a beam corresponding to the first beam identifier is at least one beam for a second reference signal.

It should be understood that a beam corresponding to the first beam identifier is at least one beam for a first reference signal, and the first offset value has a first value; and/or
a beam corresponding to the first beam identifier is at least one beam for a second reference signal, and the first offset value has a second value.

It should be understood that the beam field further includes a third beam identifier of at least one activated candidate beam;
a beam corresponding to the third beam identifier is used for the downlink transmission in the SBFD time unit; and/or a beam corresponding to a fourth beam identifier is used for the downlink transmission in the DL time unit; and
the fourth beam identifier is determined based on the third beam identifier and a second offset value.

In some embodiments, a beam corresponding to the third beam identifier is at least one beam that transmits a third reference signal; and/or a beam corresponding to the third beam identifier is at least one beam that transmits a fourth reference signal.

It can be understood that a beam corresponding to the third beam identifier is at least one beam that transmits a third reference signal, and the second offset value has a third value; and/or
a beam corresponding to the third beam identifier is at least one beam that transmits a fourth reference signal, and the second offset value has a fourth value.

Embodiments of the present disclosure provide a communications device including:
a memory for storing processor-executable instructions; and
a processor, each connected to the memory;
the processor is configured to perform the information processing method provided in any of the aforementioned technical solutions.

The processor can include various types of storage media, which are non-transitory computer storage media that can continue to store information thereon after the communication device loses power.

Herein, the communication device includes the user equipment (UE) or the network device.

The processor can be connected to a memory via a bus, etc., and configured to read an executable program stored in the memory, for example, as shown in any of the methods illustrated in FIG. 4A, 4B, 5A, 5B, 7 or 8.

Embodiments of the present disclosure provide a communication system, including:
a user equipment (UE) configured to perform the information processing method performed by the UE in any of the aforementioned embodiments.

Also, a network device configured to perform the information processing method performed by the network device in any of the aforementioned embodiments.

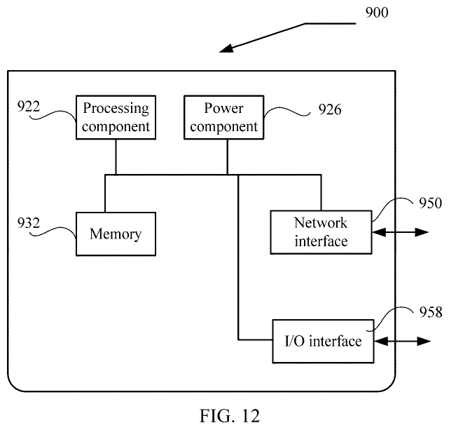

FIG. 11 is a block diagram of a UE 800 according to one or more embodiments. For example, the UE 800 can be a mobile phone, a computer, a digital broadcast user equipment, a messaging device, a game console, a tablet device, a medical device, a fitness device, a personal digital assistant, etc.

As shown in FIG. 11, the UE 800 can include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the UE 800, such as operations associated with display, telephone call, data communication, camera operation, and recording operations. The processing component 802 may include one or more processors to execute instructions to complete all or part of the methods described above. In addition, the processing component 802 may include one or more modules to facilitate interactions between the processing component 802 and other components. For example, the processing component 802 may include a multimedia module to facilitate the interaction between the multimedia component 808 and the processing component 802.

The memory 804 is configured to store various types of data to support operations on the UE 800. Examples of such data include instructions, contact data, phone book data, messages, pictures, videos, and the like for any application or method operating on the UE 800. The memory 804 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 806 provides power for various components of the UE 800. The power component 806 can include a power management system, one or more power supplies, and other components associated with generating, managing, and distributing power for the UE 800.

The multimedia component 808 includes a display screen providing an output interface between the UE 800 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 808 includes a front camera and/or a rear camera. When the UE 800 is in operation mode, such as shooting mode or video mode, the front camera and/or rear camera can receive external multimedia data. Each front camera and rear camera can be a fixed optical lens system or have focal length and optical zoom capability.

The audio component 810 is configured to output and/or input audio signals. For example, the audio component 810 includes a microphone (MIC), which is configured to receive an external audio signal when the UE 800 is in an operation mode, such as a calling mode, a recording mode, and a voice recognition mode. The received audio signal may be further stored in memory 804 or transmitted via communication component 816. In some embodiments, the audio component 810 also includes a speaker for outputting audio signals.

The I/O interface 812 provides an interface between the processing component 802 and peripheral interface modules, which can be a keyboard, click wheel, button, etc. These buttons may include, but are not limited to, the Home button, Volume button, Start button, and Lock button.

The sensor component 814 includes one or more sensors for providing various aspects of condition evaluation for the UE 800. For example, the sensor component 814 can detect an open/closed state of the UE 800, relative positioning of the components. The component is, for example, a display and a keypad of the UE 800. The sensor component 814 can also detect changes in the position of the UE 800 or one component of the UE 800, presence or absence of the user's contact with the UE 800, orientation or acceleration/deceleration of the UE 800 and temperature change of the UE 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the UE 800 and other devices. The UE 800 can access wireless networks based on communication standards, such as WiFi, 2G or 3G, or a combination thereof. In some embodiments, the communication component 816 receives a broadcast signal or broadcast related information from an external broadcast management system via a broadcast channel. In some embodiments, the communication component 816 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the UE 800 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as a memory 804 including instructions, which can be executed by the processor 820 of the UE 800 to complete above methods. For example, the non-transitory computer-readable storage medium can be ROM, random access memory (RAM), CD-ROM, tapes, floppy disks, optical data storage devices, etc.

As shown in FIG. 12, embodiments of the present disclosure provide a structure of a network device. For example, the network device 900 can be provided as a device at the network side. The communication device can be various network elements such as the aforementioned access network elements and/or network functions.

As shown in FIG. 12, the network device 900 includes a processing component 922, which further includes one or more processors, as well as memory resources represented by the memory 932, for storing instructions that can be executed by the processing component 922, such as application programs. The application program stored in the memory 932 can include one or more modules each corresponding to a set of instructions. In addition, the processing component 922 is configured to execute instructions to perform any of the methods previously applied to the network device, for example, the methods as shown in any of FIG. 4A, FIG. 4B, FIG. 5A, FIG. 5B, FIG. 7, or FIG. 8.

The network device 900 can also include a power component 926 configured to perform power management for the network device 900, a wired or wireless network interface 950 configured to connect the network device 900 to the network, and an input/output (I/O) interface 958. The network device 900 can operate operating systems stored on memory 932, such as Windows Server™, Mac OS X™, Unix™, Linux™, FreeBSD™, or similar.

In the absence of contradiction, each step in a certain embodiment or example can be implemented as an independent embodiment, and the steps can be arbitrarily combined. For example, a solution after removing some steps in a certain embodiment or example can also be implemented as an independent embodiment, and the order of the steps in a certain embodiment or example can be arbitrarily exchanged. In addition, the optional methods or optional implements in a certain embodiment or example can be arbitrarily combined. In addition, the various embodiments or examples can be arbitrarily combined. For example, some or all steps of different embodiments or examples can be arbitrarily combined, and a certain embodiment or example can be arbitrarily combined with the optional methods or optional implements of other embodiments or examples.

After considering the specification and practices of the invention disclosed herein, those skilled in the art will easily come up with other implementation solutions of the present disclosure. The present disclosure intends to cover any variations, uses, or adaptive changes of the present disclosure, which follow the general principles of the present disclosure and include common knowledge or commonly used technical means in the art that are not disclosed in the present disclosure. The specification and embodiments are only considered as exemplary, and the true scope and spirit of the present disclosure are defined by appended claims.

It should be understood that embodiments of the present disclosure are not limited to the precise structure described in the above and shown in the drawings, and various modifications and changes can be made without departing from its scope. The scope of the present disclosure is limited only by the appended claims.

1. An information processing method, performed by a user equipment (UE), the method comprising:
receiving beam indication information sent by a network device, wherein the beam indication information is configured to indicate a beam for transmission in a Sub Band Full Duplex (SBFD) time unit.

2. (canceled)

3. The method according to claim 1, wherein the beam indication information comprises candidate beam information comprised in a Radio Resource Control (RRC) message, the candidate beam information being configured to indicate a candidate beam for the SBFD time unit; and wherein the RRC message comprises at least one of:
first candidate beam information and second candidate beam information comprised in the RRC message, wherein the first candidate beam information is configured to indicate a candidate beam for a downlink (DL) time unit, and the second candidate beam information is configured to indicate the candidate beam for the SBFD time unit; or
third candidate beam information comprised in the RRC message, wherein the third candidate beam information is configured for transmission in both the DL time unit and the SBFD time unit.

4. (canceled)

5. The method according to claim 1, wherein the beam indication information comprises information related to beam activation comprised in a Media Access Control (MAC) Control Element (CE), the information related to the beam activation being configured to activate or deactivate at least one candidate beam; and wherein the information related to the beam activation comprises:
first information related to the beam activation comprised in a first field of the MAC CE, wherein the first information is configured to activate or deactivate at least one candidate beam for a DL time unit; and
second information related to the beam activation comprised in a second field of the MAC CE, wherein the second information is configured to activate or deactivate at least one candidate beam for the SBFD time unit;
wherein an MAC CE used to activate or deactivate the candidate beam for the DL time unit is different from an MAC CE used to activate or deactivate the candidate beam for the SBFD time unit;
wherein at least one of:
the MAC CE used to activate or deactivate the candidate beam for the SBFD time unit is transmitted in the SBFD time unit; or
the MAC CE used to activate or deactivate the candidate beam for a DL time unit is transmitted in the DL time unit.

6.-9. (canceled)

10. The method according to claim 21, wherein the beam indication information comprises scheduling information comprised in Downlink Control Information (DCI), the scheduling information being configured to schedule one or more activated beams for SBFD transmission;
wherein at least one of:
downlink transmission scheduled by the DCI is located in the SBFD time unit, and the scheduling information is further configured to indicate that at least one activated candidate beam is used for transmission in the SBFD time unit; or
the downlink transmission scheduled by the DCI is located in a DL time unit, and the scheduling information is further configured to indicate that at least one activated candidate beam is used for transmission in the DL time unit;
wherein the scheduling information comprises a beam field configured to indicate that at least one activated candidate beam is scheduled;
wherein the beam field indicates a first beam identifier of the at least one activated candidate beam;
and at least one of: a beam corresponding to the first beam identifier is used for downlink transmission in a DL time unit, or a beam corresponding to a second beam identifier is used for downlink transmission in the SBFD time unit; and
wherein the second beam identifier is determined based on the first beam identifier and a first offset value;
wherein the beam corresponding to the first beam identifier comprises at least one of:
the beam corresponding to the first beam identifier is at least one beam for a first reference signal; or
the beam corresponding to the first beam identifier is at least one beam for a second reference signal.

11.-15. (canceled)

16. An information processing method, performed by a network device, the method comprising:
sending beam indication information to a user equipment (UE), wherein the beam indication information is configured to indicate a beam for transmission in a Sub Band Full Duplex (SBFD) time unit.

17. The method according to claim 16, wherein the beam indication information comprises at least one of:
candidate beam information comprised in a Radio Resource Control (RRC) message, wherein the candidate beam information is configured to indicate a candidate beam for the SBFD time unit;
information related to beam activation comprised in a Media Access Control (MAC) Control Element (CE), wherein the information related to the beam activation is configured to activate or deactivate at least one candidate beam; or
scheduling information comprised in Downlink Control Information (DCI), wherein the scheduling information is configured to schedule one or more activated beams for SBFD transmission.

18. The method according to claim 17, wherein the RRC message comprises at least one of:
first candidate beam information and second candidate beam information comprised in the RRC message, wherein the first candidate beam information is configured to indicate a candidate beam for a downlink (DL) time unit, and the second candidate beam information is configured to indicate the candidate beam for the SBFD time unit; or
third candidate beam information comprised in the RRC message, wherein the third candidate beam information is configured for transmission in both the DL time unit and the SBFD time unit.

19. (canceled)

20. The method according to claim 17, wherein the information related to the beam activation comprises:
first information related to the beam activation comprised in a first field of the MAC CE, wherein the first information is configured to activate or deactivate at least one candidate beam for a DL time unit; and
second information related to the beam activation comprised in a second field of the MAC CE, wherein the second information is configured to activate or deactivate at least one candidate beam for the SBFD time unit.

21. (canceled)

22. The method according to claim 17, wherein at least one of:
an MAC CE used to activate or deactivate the candidate beam for the SBFD time unit is transmitted in the SBFD time unit; or
an MAC CE used to activate or deactivate the candidate beam for a DL time unit is transmitted in the DL time unit.

23. The method according to claim 17, wherein bits of the MAC CE comprise a first-category bit and a second-category bit;
the first-category bit is a high-order bit relative to the second-category bit, or the second-category bit is the high-order bit relative to the first-category bit;
and at least one of: the first-category bit comprises first information, or the second-category bit comprises second information.

24. The method according to claim 23, wherein the MAC CE further comprises an indication bit, wherein the indication bit is configured to indicate whether the information related to the beam activation comprised in the MAC CE is for the SBFD time unit or a DL time unit.

25. The method according to claim 17, wherein at least one of:
downlink transmission scheduled by the DCI is located in the SBFD time unit, and the scheduling information is further configured to indicate that at least one activated candidate beam is used for transmission in the SBFD time unit; or
the downlink transmission scheduled by the DCI is located in a DL time unit, and the scheduling information is further configured to indicate that at least one activated candidate beam is used for transmission in the DL time unit

26. The method according to claim 25, wherein the scheduling information comprises a beam field configured to indicate that at least one activated candidate beam is scheduled.

27. The method according to claim 25, wherein the beam field indicates a first beam identifier of the at least one activated candidate beam;
and at least one of: a beam corresponding to the first beam identifier is used for downlink transmission in a DL time unit, or a beam corresponding to a second beam identifier is used for downlink transmission in the SBFD time unit; and
wherein the second beam identifier is determined based on the first beam identifier and a first offset value.

28. The method according to claim 27, wherein the beam corresponding to the first beam identifier comprises at least one of:
the beam corresponding to the first beam identifier is at least one beam for a first reference signal; or
the beam corresponding to the first beam identifier is at least one beam for a second reference signal.

29. The method according to claim 25, wherein the beam field further indicates a third beam identifier of the at least one activated candidate beam;
and at least one of: a beam corresponding to the third beam identifier is used for the downlink transmission in the SBFD time unit; or a beam corresponding to a fourth beam identifier is used for the downlink transmission in the DL time unit; and
wherein the fourth beam identifier is determined based on the third beam identifier and a second offset value.

30. The method according to claim 29, wherein the beam corresponding to the third beam identifier comprises at least one of:
the beam corresponding to the third beam identifier is at least one beam that transmits a third reference signal; or
the beam corresponding to the third beam identifier is at least one beam that transmits a fourth reference signal.

31.-33. (canceled)

34. A network device, comprising a processor, and a memory, wherein an executable program is stored in the memory and executable by the processor, and the processor is configured to:
send beam indication information to a user equipment (UE), wherein the beam indication information is configured to indicate a beam for transmission in a Sub Band Full Duplex (SBFD) time unit.

35. A non-transitory computer storage medium having an executable program stored thereon, which when executed by a processor, the information processing method according to claim 16 is implemented.

36. A user equipment (UE), comprising a processor, and a memory, wherein an executable program is stored in the memory and executable by the processor, and the processor is configured to perform the information processing method according to claim 1.
